(19) United States
(12) Patent Application Publication
(10) Pub. No.: US 2026/0284606 A1
(43) Pub. Date: Sep. 24, 2026

(54) CONDUCTIVE BASE MEMBRANE AND PREPARATION METHOD THEREOF

(71) Applicant: BEIJING BAOSHENGTONG INTERNATIONAL ELECTRICAL ENGINEERING TECHNOLOGY CO., LTD., Beijing City (CN)

(72) Inventors: CHUN TANG, Beijing City (CN); CONG MA, Beijing City (CN)

(73) Assignee: BEIJING BAOSHENGTONG INTERNATIONAL ELECTRICAL ENGINEERING TECHNOLOGY CO., LTD., Beijing City (CN)

(21) Appl. No.: 19/680,911

(22) Filed: May 18, 2026

Related U.S. Application Data
(63) Continuation of application No. PCT/CN2024/123522, filed on Oct. 9, 2024.

(30) Foreign Application Priority Data
Jun. 19, 2024 (CN) 202410795321.9

(51) Int. Cl. B01D 71/60; B01D 61/00; B01D 67/00; B01D 69/10; B01D 69/12

(52) U.S. Cl. CPC B01D 71/60; B01D 61/002; B01D 67/0086; B01D 67/0095; B01D 69/108; B01D 69/1216; B01D 69/1251; B01D 69/127; B01D 2323/21815; B01D 2325/26

(57) ABSTRACT

A conductive forward osmosis membrane and its preparation method belong to the field of water treatment technology. The present application uses a conductive porous substrate as a support layer, and the substrate is modified by electrochemical deposition of electrochemical materials to obtain a conductive material layer. The conductive forward osmosis membrane of this application is used as a base film for water treatment membranes, and has good conductivity, fouling resistance and stability, which improves the performance of the membrane and the efficiency of water treatment, and at the same time, it has a reusability, which reduces the application cost as a whole.

### CROSS-REFERENCE TO RELATED APPLICATIONS

This application is a continuation application of international Application No. PCT/CN2024/123522, filed Oct. 9, 2024, which claims the benefit of Chinese Patent Application No. 202410795321.9, filed in China on Jun. 19, 2024. The disclosures of these applications are hereby incorporated by reference in their entirety.

### TECHNICAL FIELD

The present invention relates to the field of membrane technology, specifically to the field of membrane material technology applied in water treatment technology, and more particularly to a conductive base membrane applied in water treatment membranes and a preparation method thereof.

### BACKGROUND

Electrochemically assisted conductive forward osmosis (FO) membranes, compared to non-conductive FO membranes coupled with electrochemistry, use the prepared conductive FO membrane directly as a cathode or anode. This not only offers advantages such as compact device setup and ease of handling but also significantly reduces the mass transfer resistance between pollutants and the electrode. The preparation of conductive FO membranes can be broadly categorized into the following methods: through conductive modification of the selective layer. Most conductive modifications of the selective layer involve coating conductive materials onto the polyamide layer. However, the greatest drawback of this coating method is limited uniformity, which significantly weakens the conductive properties of the composite membrane. Another method involves conductive modification of the support layer by coating conductive materials onto it. However, this coating method for preparing the conductive layer also faces critical issues of uniformity and conductivity. For example, existing Chinese Patent CN112473372B proposes depositing a two-dimensional MXene materials on a polymer membrane support layer, followed by interfacial polymerization to produce a conductive FO membrane. However, since the support layer is a non-conductive material, it not only has relatively high resistivity but also suffers from gradual performance decline during long-term operation due to the loss of conductive additives. Therefore, there is a need for a conductive base membrane that combines good conductivity and stability.

### SUMMARY

To solve the above technical problems, the present invention provides a preparation method for a conductive base membrane and the conductive base membrane itself, which have good conductivity and stability.

To achieve the above purpose, one aspect of the present application provides a preparation method for a conductive base membrane, comprising:
Step 1: Obtaining a conductive porous substrate of a suitable size, and performing a neutral treatment on the conductive substrate;
Step 2: Performing electrochemical material deposition on the substrate from step 1 to obtain a conductive material layer, wherein the conductive material layer is a material having negative electrons and high hydrophilicity.

Further, the conductive porous substrate is conductive porous carbon paper.

Further, the conductive material layer is a polypyrrole layer.

Further, the solution for electrochemical deposition in the step 2 is an electrochemical polymer, which is a mixture of pyrrole and H₂SO₄.

Further, the mixture of pyrrole and H₂SO₄ is obtained by the following method: fully dissolving 10.35 mL (0.15 mol) of pyrrole solution, 3.0 mL of ethylene glycol, 3.0 mL of oxalic acid, and 13.40 g of sodium dodecyl benzene sulfonate (SDBS) in 500 mL deionized water; taking 16.1 mL of concentrated sulfuric acid (98%) and completely dissolving it in 500 mL deionized water; and finally mixing the two solutions to obtain the electrochemical polymer.

Another aspect of the present application provides a conductive base membrane, comprising a support layer, wherein the support layer is constituted by a conductive porous substrate, a conductive material layer is disposed on the support layer, the conductive base membrane has high hydrophilicity, a porous structure, and carries a negative charge; and the surface of the conductive base membrane has a smooth morphology and a multi-pore size structure with uniform roughness; wherein the conductive base membrane is prepared by the preparation method for a conductive base membrane described above.

Further, the surface pore size of the conductive base membrane is 0.93±4.5~14.97±8.7 μm, and the porosity is 30.4±1.3%~36.4±2.0%.

Further, the surface pore size of the conductive base membrane is 1.08±3.4 μm, and the porosity is 34.6±1.7%; or the surface pore size of the conductive base membrane is 1.08 μm, and the porosity is 34.6%; the water contact angle of the base membrane is 29°~88°.

Further, the porosity of the support layer is 41.4±1.5%, and the average pore size is 280±11.4 μm; or the porosity of the support layer is 41.1%, and the average pore size is 280 μm.

Further, the support layer is conductive porous carbon paper, and the conductive material layer is a polypyrrole layer.

The beneficial effects of the present application are:

The present application forms a conductive base membrane comprising a conductive porous substrate support layer and a conductive material polymer layer through electrochemical material deposition on the conductive porous substrate. It exhibits excellent conductivity and low resistivity, along with porous permeability, superior conductivity, low contact resistance, and good mechanical strength. When applied to FO membranes for water treatment, it significantly enhances the water treatment capacity of the conductive FO membrane.

The present application first performs a neutral treatment on the conductive porous substrate and then deposits the electrochemical material, which enhances the adhesion of the electrochemical materials to the conductive porous substrate, improves the overall strength and stability of the base membrane, allows for reuse and regeneration of the selective layer, and reduces costs.

Furthermore, the FO membrane obtained by performing interfacial polymerization of the selective layer on the conductive base membrane of the present application enhances the conductive performance, surface structure smoothness, and nanofiltration performance of the conductive FO membrane.

Simultaneously, the conductive base membrane provided by the present application, with its strong conductivity and stability, when applied to conductive FO membranes, enhances the membrane's anti-fouling effect under applied voltage. This improves the removal efficiency of pollutants in FO filtration, and ensures membrane stability.

### BRIEF DESCRIPTION OF THE DRAWINGS

FIG. 1-1 is a flowchart of the method for preparing the conductive base membrane provided in the present application;

FIG. 1-2 is a flowchart of the method for preparing the conductive FO membrane provided in the present application;

FIG. 1-3 is a flowchart for preparing a conductive FO membrane using conductive carbon paper as the substrate in an embodiment of the present application;

FIGS. 2a-20 are scanning electron microscope (SEM) images of the surfaces of conductive porous carbon paper base membranes obtained by depositing electrochemical polymer polypyrrole at different concentrations on a pure conductive porous carbon paper substrate with different deposition cycle numbers (200, 400, 500, 600, 700) in different embodiments of the present application;

FIG. 3 is an experimental schematic diagram of permeability for a comparative base membrane of pure conductive porous carbon paper substrate and conductive porous carbon paper base membranes with different polypyrrole deposition concentrations in different embodiments of the present application;

FIG. 4 is an experimental schematic diagram of the sheet resistance for a comparative base membrane of pure conductive porous carbon paper substrate and conductive porous carbon paper base membranes with different polypyrrole deposition concentrations in different embodiments of the present application;

FIG. 5 is an experimental schematic diagram of the contact angle for a comparative base membrane of pure conductive porous carbon paper substrate and conductive porous carbon paper base membranes with different polypyrrole deposition cycle numbers in different embodiments of the present application;

FIG. 6 is an experimental schematic diagram of the Zeta potential for a comparative base membrane of pure conductive porous carbon paper substrate and conductive porous carbon paper base membranes with different polypyrrole deposition cycle numbers in different embodiments of the present application;

FIGS. 7a-7f are experimental schematic diagrams of atomic force microscope (AFM) for a comparative base membrane of pure conductive porous carbon paper substrate and conductive porous carbon paper base membranes with different polypyrrole deposition cycle numbers in different embodiments of the present application;

FIGS. 8a1-8a6 and 9b1-9b6 are SEM images comparing the surfaces of FO membranes formed on a pure conductive porous carbon paper substrate with conductive FO membranes obtained by adding an intermediate layer of polypyrrole at different concentrations in different embodiments of the present application;

FIGS. 9c1-9c6 are cross-sectional SEM images comparing FO membranes formed on a pure conductive porous carbon paper substrate with conductive FO membranes obtained by adding an intermediate layer of polypyrrole deposited with different cycle numbers in different embodiments of the present application;

FIGS. 10a-10f are surface AFM images of a comparative FO membrane formed on a pure conductive porous carbon paper substrate and FO membranes obtained by adding an intermediate layer of polypyrrole deposited with the same concentration but different cycle numbers in different embodiments of the present application;

FIG. 11 shows schematic diagram of contact angles for a comparative FO membrane formed on a pure conductive porous carbon paper substrate and FO membranes obtained by adding an intermediate layer of polypyrrole deposited with the same concentration but different cycle numbers in different embodiments of the present application;

FIG. 12 shows X-ray photoelectron spectroscopy (XPS) schematic diagram for a comparative FO membrane formed on a pure conductive porous carbon paper substrate and FO membranes obtained by adding an intermediate layer of polypyrrole deposited with the same concentration but different cycle numbers in different embodiments of the present application;

FIG. 13 shows cyclic voltammetry diagram for a comparative FO membrane formed on a pure conductive porous carbon paper substrate and FO membranes obtained by adding an intermediate layer of polypyrrole deposited with the same concentration but different cycle numbers in different embodiments of the present application;

FIG. 14 shows electrochemical impedance spectroscopy (EIS) schematic diagram for a comparative FO membrane formed on a pure conductive porous carbon paper substrate and FO membranes obtained by adding an intermediate layer of polypyrrole deposited with the same concentration but different cycle numbers in different embodiments of the present application;

FIG. 15 is a diagram of a cross-flow forward osmosis (FO) device for testing the permeate and selectivity of FO membranes;

FIGS. 16a and 16b shows the performance diagrams of a comparative FO membrane formed on a pure conductive porous carbon paper substrate and FO membranes obtained by adding an intermediate layer of polypyrrole deposited with the same concentration but different cycle numbers in different embodiments of the present application, under FO mode (polyamide layer facing the feed solution) and PRO mode (polyamide layer facing the draw solution);

FIG. 17a is a schematic diagram of the permeability coefficient (A value) and salt permeability coefficient (B value) for a comparative FO membrane formed on a pure conductive porous carbon paper base membrane and FO membranes obtained by adding an intermediate layer of polypyrrole deposited with the same concentration but different cycle numbers in different embodiments of the present application;

FIG. 17b is a schematic diagram of the salt rejection rates for a comparative FO membrane formed on a pure conductive porous carbon paper base membrane and FO membranes obtained by adding an intermediate layer of polypyrrole deposited with the same concentration but different cycle numbers in different embodiments of the present application;

FIGS. 18a and 18b are schematic diagrams comparing water flux and reverse salt flux, for a conductive FO membrane with a polypyrrole deposition cycle number of 600 at different draw solution concentrations;

FIGS. 19a-19b are schematic diagrams showing changes in membrane flux of the conductive FO membrane in application examples of the present application under different applied voltages;

FIGS. 20a-20g illustrate schematic diagrams of the cake layer thickness in the cross-section of the conductive positive permeation membrane under different applied voltages in the application examples of the present invention;

FIGS. 21a-21d are schematic diagrams showing the effects of individual and mixed algal water components on membrane performance for the conductive FO membrane in application examples of the present application under different applied voltages;

FIGS. 22a, 22a1-22g1, 22a2-22g2, 22a1′-22g1′, 22a2′-22g2′ are SEM images of the conductive FO membrane in embodiments of the present application under different algal water components and different applied voltages;

FIGS. 23a-23e illustrate the effects of applying different voltages on the performance of the conductive positive permeation membrane in the application examples of this patent, as demonstrated in algal water supplemented with Ca²⁺;

FIGS. 24a-24e are schematic diagrams showing the effects of co-existing Humic Acid (HA) in algal water on the performance of the membrane in application examples of the present application under different applied voltages;

FIGS. 25a-25e are schematic diagrams showing the effects of co-existing Kaolinite in algal water on the performance of the membrane in application examples of the present application under different applied voltages;

FIGS. 26a and 26b respectively show the membrane flux change during long-term operation for the FO membrane (CPFO) of an embodiment of the present application and the regenerated FO membrane (CPFO-C) after peeling off the selective layer, and the spectrum of the intermediate layer after peeling the CPFO membrane selective layer;

FIGS. 27a-27f are SEM images of the conductive FO membrane before and after peeling in the embodiments of the present application.

### DETAILED DESCRIPTION

To make the technical means, creative features, purposes, and effects of the present application easily understood, the following further elaborates the present application with specific diagrams and tables.

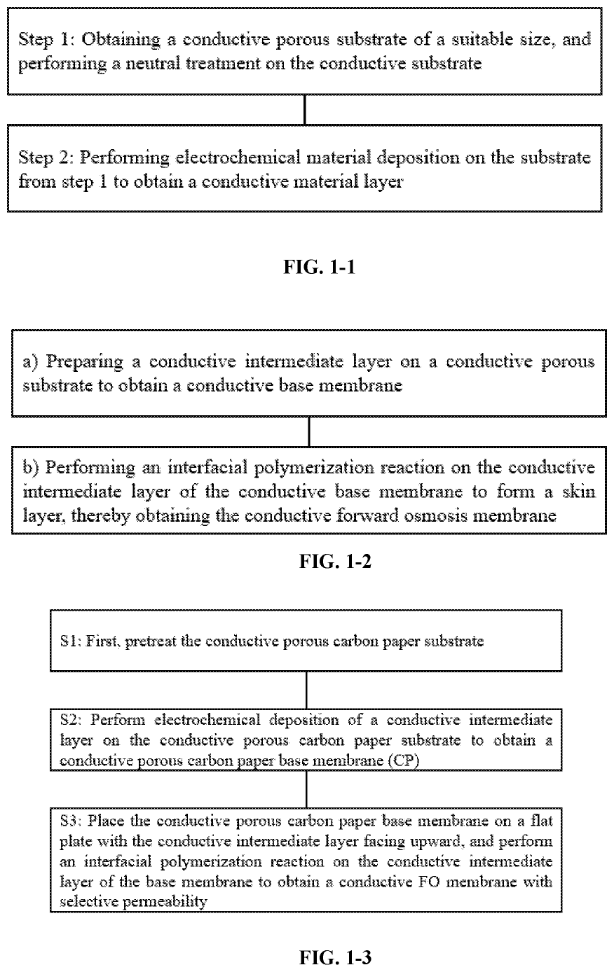

As shown in FIG. 1-1, the present application provides a method for preparing a conductive base membrane, which comprises:
Step 1: Obtaining a conductive porous substrate of a suitable size, and performing neutral treatment on the conductive substrate;
Step 2: Depositing electrochemical material onto the substrate from step 1 to obtain a conductive material layer.

Further, the conductive material layer comprises a highly hydrophilic material with negative electrons; the conductive porous substrate is conductive porous carbon paper.

Further, the conductive material layer is a polypyrrole layer.

Further, the solution for electrochemical deposition in the step 2 is an electrochemical polymer, which is a mixture of pyrrole and H₂SO₄.

Further, the mixture of pyrrole and H₂SO₄ is obtained by the following method: fully dissolving 10.35 mL (0.15 mol) of pyrrole solution, 3.0 mL of ethylene glycol, 3.0 mL of oxalic acid, and 13.40 g of sodium dodecyl benzene sulfonate (SDBS) in 500 mL deionized water; taking 16.1 mL of concentrated sulfuric acid (98%) and completely dissolving it in 500 mL deionized water; and finally mixing the two solutions to obtain the electrochemical polymer.

The present application further provides a conductive base membrane comprising a support layer, wherein the conductive base membrane is prepared by the aforementioned method for preparing a conductive base membrane described above.

Further, wherein the support layer is constituted by a conductive porous substrate, a conductive material layer is disposed on the support layer, the conductive base membrane has high hydrophilicity, a porous structure; the surface of the conductive base membrane has a smooth morphology and a multi-pore size structure with a uniform roughness.

Further, the surface pore size of the conductive base membrane is 0.93±4.5~14.97±8.7 μm, and the porosity is 30.4±1.3%~36.4±2.0%.

Further, the surface pore size of the conductive base membrane is 1.08±3.4 μm, with a porosity of 34.6±1.7%; or the surface pore size of the conductive base membrane is 1.08 μm, with a porosity is 34.6%; the water contact angle of the base membrane is 29°~88°.

Further, the porosity of the support layer is 41.4±1.5%, and the average pore size is 280±11.4 μm; or the porosity of the support layer is 41.1%, and the average pore size is 280 μm.

Further, the support layer is conductive porous carbon paper, and the conductive material layer is a polypyrrole layer.

The following further explains the present application in detail through application examples of conductive FO membranes using the conductive base membrane of the present application, their preparation, and application.

The third aspect of the present application provides a conductive FO membrane using the conductive base membrane of the present application. It comprises a support layer, an intermediate layer, and a selective layer with filtration performance, wherein the support layer is constituted by a conductive porous substrate, and the intermediate layer is a conductive intermediate layer constituted by a conductive material. Please refer to FIGS. 9c2-9c6, which are schematic diagrams of the cross-sectional structure of the conductive FO membrane provided in the application.

Further, the conductive porous substrate comprises conductive porous carbon paper or conductive carbon material, which exhibits porosity and conductivity; preferably, it is conductive porous carbon paper.

Further, the conductive intermediate layer is constituted by polypyrrole material; the selective layer is a polyamide layer with a thickness of 260 nm~560 nm.

Further, the conductive material in the conductive intermediate layer additionally includes sodium dodecyl sulfate material.

Further, the polypyrrole is deposited onto the conductive porous carbon paper via electrochemical deposition of a pyrrole-containing electrochemical polymer material.

Further, the selective layer formed on the conductive intermediate layer has a smooth, ridge-and-valley morphology; the sheet resistance of the FO membrane is 156.4 mΩ/sq~300 mΩ/sq, preferably 156.4 mΩ/sq~209.3 mΩ/sq, more preferably 156.4 mΩ/sq.

Further, the average water flux of the conductive FO membrane in FO/PRO mode is 9.09~33.96 L/(m²·h), and the reverse salt flux is 3.38~21.48 g/(m²·h). More preferably the average water flux is 9.09~22.09 L/(m²·h), or 21.76~33.96 L/(m²·h); the reverse salt flux is 3.38~11.40 g/(m²·h) or 5.48~21.48 g/(m²·h). More preferably, the average water flux is 21.09 L/(m²·h), 33.96 L/(m²·h), and the average reverse salt flux is 4.61, 5.48 g/(m²·h).

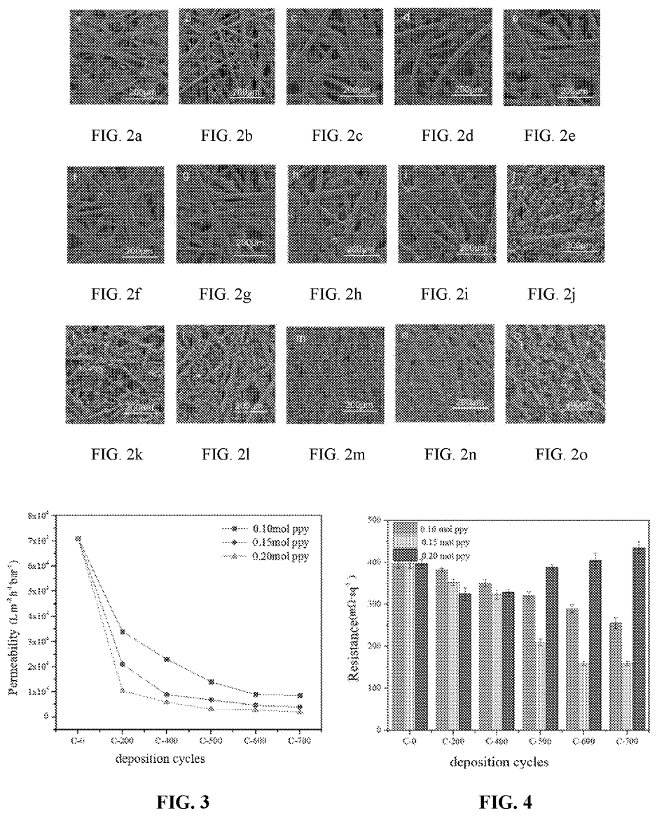

A fourth aspect of the present application provides a method for preparing a conductive FO membrane comprising the conductive base membrane of the present application, as shown in FIG. 1-2, comprising the following steps:
a) Preparing a conductive intermediate layer on a conductive porous substrate to obtain a conductive base membrane;
b) Performing an interfacial polymerization reaction on the conductive intermediate layer of the conductive base membrane to prepare a selective layer, thereby obtaining the conductive FO membrane.

Further, wherein the conductive porous substrate is conductive porous carbon paper; the conductive intermediate layer is polypyrrole.

Further, the conductive intermediate layer is prepared by electrochemically depositing a pyrrole-containing electrochemically polymerized polymer onto the surface of the conductive porous carbon paper substrate.

Further, before step a), it further includes the step of pretreating the conductive porous substrate.

Further, the pretreatment of the conductive porous substrate is performed by: obtaining a conductive porous substrate of suitable size, placing the substrate of suitable size in a petri dish for soaking, and then performing a neutral treatment on the substrate.

Further, the pretreatment of the conductive porous substrate is performed as follows: placing the conductive porous substrate of suitable size in a petri dish and soaking it in a 0.2 mol/L sodium hydroxide (NaOH) solution for a period of time, then soaking and rinsing with deionized water until neutral.

Further, the electrochemical polymer is a mixture of pyrrole and sulfuric acid (H₂SO₄).

Further, the method for preparing the selective layer is as follows: Immersing the conductive base membrane in an aqueous solution of polyamine compound at a specific concentration, maintaining full immersion for a certain time, then removing the excess aqueous solution to obtain a pretreated membrane; performing surface treatment on the pretreated membrane; pouring an organic-phase solution containing a polyamide chloride compounds onto the treated pretreated membrane to carry out an interfacial polymerization reaction, removing the excess organic solution after a second specified time, to obtain a conductive FO membrane with a polyamide selective layer.

Further, the method for preparing the polyamide layer is as follows: slowly pouring 25 ml of an aqueous solution containing m-phenylenediamine (MPD) compound onto the base membrane and allowing it to soak completely for 180 s; then pouring off the excess aqueous solution, and gently rolling a rubber roller over the membrane surface to evenly distribute the aqueous solution, obtaining the pretreated membrane; then pouring 25 ml of an organic solution of trimesoyl chloride (TMC) compound onto the pretreated membrane, reacting for 90 s, then pouring off the excess organic solution to obtain an initial FO membrane; air-drying the prepared initial FO membrane for 60 s, then drying and curing for 300 s, to obtain a selective layer with selective permeability on the membrane surface.

Further, the aqueous solution is configured as follows: dissolving a solution of m-phenylenediamine compounds with a concentration of 1.0 wt %-6.0 wt % in water as the solvent in an opaque or semi-opaque container; the organic solution is configured as follows: dissolving a solution of trimesoyl chloride compound with a concentration of 0.05 wt %-0.5 wt % in n-hexane as the solvent in a container.

The original conductive porous carbon paper has high porosity and an ultra groove pore structure, with porosity and average pore size reaching 41.1% and 280 μm, respectively. After depositing the polypyrrole intermediate layer, the defects of large pores in the base membrane were compensated. The surface pore size becomes 1.08±3.4 μm, and the porosity becomes 34.6±1.7%, also giving the conductive porous carbon paper base membrane high hydrophilicity, successfully achieving the base membrane enhancement.

The polyamide layer formed on the original conductive porous carbon paper base layer has a smooth morphology but not a ridge-and-valley morphology; after depositing the intermediate layer, the defects of the rough large pores of the conductive porous carbon paper base membrane are compensated. The hydrophilicity, roughness, pore size, electrochemical characteristics, and a series of other physicochemical properties of the membrane surface change, forming a new substrate morphology that affects the morphology and performance of the polyamide layer. High hydrophilicity, reasonable small pore size, and uniform roughness provide greater reactivity and contact area for interfacial polymerization reaction, resulting in higher crosslinking density and excellent FO performance.

Please also refer to FIG. 1-3. For the conductive FO membrane and its preparation method described in the first and second aspects above, an embodiment of the present application provides a preparation method for the aforementioned conductive FO membrane using conductive porous carbon paper as the support substrate, specifically comprising:
S1: First, pretreat the conductive porous carbon paper substrate;
S2: Perform electrochemical deposition of a conductive intermediate layer on the conductive porous carbon paper substrate to obtain a conductive porous carbon paper base membrane (CP); further, deposit an electrochemical polymer on the conductive porous carbon paper to obtain the conductive intermediate layer; further, the conductive intermediate layer of the electrochemical polymer is a polypyrrole intermediate layer;
S3: Place the conductive porous carbon paper base membrane on a flat plate with the conductive intermediate layer facing upward, and perform an interfacial polymerization reaction on the conductive intermediate layer of the base membrane to obtain a conductive FO membrane with selective permeability.

The preparation method for the conductive FO membrane provided in the embodiment of the present application is further elaborated as follows:

In the step S1: Cut a suitable-sized conductive porous carbon paper substrate (e.g., 10×10 cm) to dimensions such as 5×10 cm using a craft knife. Immerse the substrate in a sodium hydroxide solution of a specific concentration (e.g., 0.2 mol/L NaOH) within a petri dish for a defined period (e.g., 2 hours) to enhance the bonding strength between the electrochemical polymer (e.g., polypyrrole intermediate layer) and the conductive porous carbon paper substrate. After soaking, continue soaking and rinsing with deionized water until neutral.

In the step S2: Prepare the conductive porous carbon paper-based membrane with a polypyrrole intermediate layer: Electrochemical polymerization of polypyrrole is performed using a three-electrode system. First, prepare the electrochemical polymerization solution, which is a mixture of pyrrole and H₂SO₄. The two solutions are mixed in a reactor for polymerization. Place the reactor in a magnetic stirrer, set the stirring speed and the temperature around the reactor, set the electrochemical polymerization mode to cyclic voltammetry (CV), set a fixed voltage scan ranges, scan rate, and cycle numbers, and name the CP membranes after polypyrrole deposition as CP-n according to the number of cycles.

In the step S3, the conductive FO membrane obtained by interfacial polymerization reaction on the base membrane is obtained by interfacial polymerization reaction on the base membrane with the deposited intermediate layer to obtain a conductive FO membrane with a polyamide layer, including the following steps:
S4: Soak the base membrane in an aqueous solution containing a polyamine compound, remove excess aqueous solution from the base membrane after the first specified time, and obtain a pretreated membrane;
S5: Perform surface treatment on the pretreated membrane;
S6: Pour the organic phase solution containing polyacrylic chloride compounds onto the pretreated membrane processed in step S5 to perform an interfacial polymerization reaction. After a second specified time, remove the excess organic solution to obtain a conductive FO membrane with a polyamide layer.

In the step S3: Place the base membrane flat on a smooth plate with the base membrane facing upward. In the embodiments of the present application, the smooth plate is a smooth glass plate. Further, it also includes a custom-sized rubber ring and a stainless steel frame. The rubber ring and stainless steel frame are fixed to the glass plate, and further including an installation fixing device and leakage prevention device.

Furthermore, it includes steps for preparing the aqueous solution and the organic solution separately.

Further, the aqueous solution is a polyamine compound aqueous solution, and the organic solution is a polyacrylic chloride compound organic solution. In the embodiments of the present application, the aqueous solution is an m-phenylenediamine aqueous solution, and the organic solution is a trimesoyl chloride organic solution.

Further, the step S4 involves pouring the aqueous solution into the frame to soak the base membrane, removing the excess aqueous solution after the first specified time and dismantling the fixing device and leakage prevention device, to obtain a pretreated membrane with an aqueous solution of amine monomer on its surface.

Further, the step S5 involves using a collection roller to roll over the surface of the pretreated membrane to distribute the aqueous solution containing the amine monomer evenly, making the membrane flatter. In the embodiments of the present application, the collection roller is made of rubber.

Further, the step S6 involves pouring the organic phase solution into the frame for reaction, and pouring off the excess organic phase solution after the second specified time; since the two solutions are immiscible, the amine monomer in the aqueous phase diffuses towards the organic solution, and the monomers in both phases can only contact and react at the interfacial boundary. Combined with the extremely fast reaction rate between monomers, a polyamide layer can be formed on the surface of the conductive intermediate layer of the conductive porous base membrane in a very short time.

It further includes the following step S7: Naturally air-dry the prepared conductive FO membrane, then cure it, and after a third specified time, obtain the conductive FO membrane with the polyamide layer;
S8: Store the conductive FO membrane with the polyamide layer in deionized water until testing; further, store it in deionized water at a temperature of 4° C.

In a further embodiment, the process for preparing the aqueous solution is: dissolving m-phenylenediamine in deionized water in an opaque container, such as a brown container, and then sonicate for 10 min-50 min.

In a further embodiment, the process for preparing the organic phase solution is: dissolving 1,3,5-benzenetricarbonyl chloride (TMC) in n-hexane solvent, and then sonicate for 10 min-50 min. Further, in the embodiment of the present application, dissolve TMC with a concentration of 0.15 wt % in 50 ml of n-hexane solution, and sonicate for 30 minutes to dissolve it completely.

In a further embodiment, the mass percentage of m-phenylenediamine in the aqueous phase solution is 1.0 wt %-6.0 wt %, further preferably 3 wt %; the mass percentage of trimesoyl chloride in the organic phase solution is 0.05 wt %-0.5 wt %, further preferably 0.15 wt %.

In a further embodiment, the first specified time is 3-7 minutes, further preferably 5 minutes; the second specified time is 1-6 minutes, further preferably 2 minutes; the third specified time is 30-90 seconds, further preferably 60 seconds.

In the description of the embodiments of the present application, including the accompanying drawings, the following terms, unless otherwise specified, are expressed as follows: Conductive porous carbon paper base membrane (CP) represents the conductive porous carbon paper base membrane after electrochemical deposition on the conductive porous carbon paper substrate.

Conductive FO membrane represents the conductive FO membrane prepared after the interfacial polymerization reaction process on the conductive porous carbon paper base membrane. The conductive porous carbon paper base membranes CP-0, CP-200, CP-400, CP-500, CP-600, CP-700 according to the polypyrrole deposition cycle numbers, and the conductive FO membranes prepared through the interfacial polymerization reaction process are named CPFO₀ membrane, CPFO₂₀₀ membrane, CPFO₄₀₀ membrane, CPFO₅₀₀ membrane, CPFO₆₀₀ membrane, CPFO₇₀₀ membrane, respectively. The experiments, tests, parameter descriptions, etc., in each embodiment of this example, if there are corresponding expressions, are all performed for the above entities. The selective layer is the polyamide layer. Draw concentration represents the draw solution concentration. Water flux represents the water permeation rate. Reverse salt flux represents the salt rejection rate.

In the embodiments of the present application, the deposition concentration of the electrochemical polymer polypyrrole is 0.1 mol/L-0.2 mol/L, and the cycle number is 200-700 cycles, specifically 200, 400, 500, 600, 700 cycles; preferably, a further embodiment of the present application uses an electrochemical polymer polypyrrole deposition concentration of 0.15 mol/L and a cycle number of 600 cycles.

FIGS. 2a-20 show SEM images of the surfaces of conductive porous carbon paper base membranes with different concentrations of electrochemical polymer polypyrrole at different deposition cycle numbers (200, 400, 500, 600, 700). Among them, FIGS. 2a-2e use an electrochemical polymer polypyrrole concentration of 0.1 mol/L, FIGS. 2f-2j use 0.15 mol/L, and FIGS. 2k-2o use 0.2 mol/L. From the SEM images, it can be seen that the conductive porous carbon paper base membrane formed after deposition at a lower polypyrrole concentration of 0.1 mol/L has a large surface pore size; the membrane formed after deposition at a higher concentration of 0.2 mol/L has a small surface pore size. From FIGS. 2f-2j, it can be seen that the conductive porous carbon paper base membrane formed after deposition at a polypyrrole concentration of 0.15 mol/L has a relatively uniform surface pore size, and polypyrrole can well cover the large pore structure of the conductive porous carbon paper substrate base surface and has a relatively smooth surface structure.

Table 1 shows the porosity and average pore size of the conductive porous carbon paper base membranes obtained with an electrochemical polymer polypyrrole concentration of 0.15 mol/L at different cycle layers CP-0, CP-200, CP-400, CP-500, CP-600, CP-700. Among them, CP-0, the original conductive porous carbon paper substrate, has high porosity and super-large pore structure, with porosity and average pore size reaching 41.1% and 280 μm, respectively. As the cycle number of the polypyrrole intermediate layer increases, the porosity and average pore size of CP-200, CP-400, CP-500, CP-600, CP-700 all decrease, with porosity and average pore size reaching 30.4% and 0.93 μm. This is because the deposited polypyrrole intermediate layer covers and forms, causing the decrease in porosity and average pore size. Through the interfacial polymerization reaction on the base membrane containing the intermediate layer in the embodiments of the present application, the formed selective layer floats on the surface of the conductive porous carbon paper base membrane. It does not penetrate into the base membrane or significantly reduce the penetration of the selective layer into the base membrane, improving the performance of the FO membrane.

TABLE 1
Porosity and Average Pore Size of Base Membranes

| Base | | | | | | |
|---|---|---|---|---|---|---|
| Membrane | | | | | | |
| (Different | | | | | | |
| Cycle Layers) | CP-0 | CP-200 | CP-400 | CP-500 | CP-600 | CP-700 |
| Average Pore | 280 ± 11.4 | 110.3 ± 9.5 | 50.6 ± 10 | 14.97 ± 8.7 | 1.08 ± 3.4 | 0.93 ± 4.5 |
| Size (μm) | | | | | | |
| Porosity (%) | 41.4 ± 1.5 | 39.5 ± 1.7 | 38.1 ± 0.9 | 36.4 ± 2.0 | 34.6 ± 1.7 | 30.4 ± 1.3 |

The permeability of conductive porous carbon paper base membranes obtained with different initial deposition concentrations is shown in FIG. 3. By changing the cycle number, the permeability of the conductive porous carbon paper base membrane can be adjusted to achieve a nanoscale filter.

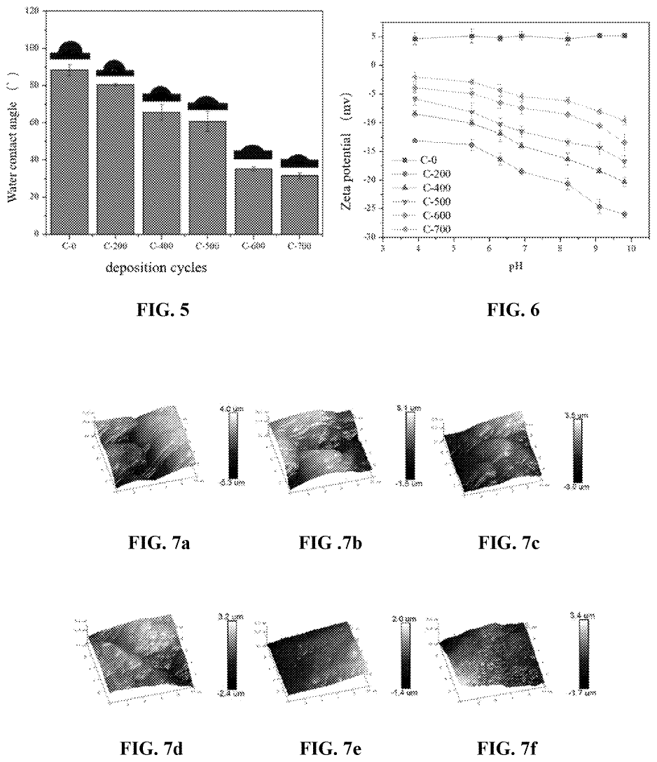

As shown in FIG. 4, it is a schematic diagram of the resistance of conductive porous carbon paper base membranes obtained with different pyrrole deposition concentrations at different deposition cycle numbers. As an important standard for evaluating conductivity, resistance exhibits an inverse relationship with a material's conductive properties. It can be seen from the figure that at low initial concentration (0.1 mol/L), as the cycle number increases, the resistance of the conductive porous carbon paper base membrane gradually decreases. This is because the macropore structure of the original conductive porous carbon paper base membrane is not unfavorable for electron transfer. The deposition of polypyrrole increases the specific surface area, reduces the ion embedding distance to the nanoscale range, promotes charge transfer, and reduces resistance. The deposition concentration of 0.15 mol/L shows an excellent trend of conductivity enhancement. Further, in the embodiment of the present application, the preferred deposition concentration of polypyrrole on the conductive porous carbon paper base membrane is 0.15 mol/L. At this concentration, the conductive porous carbon paper base membrane shows excellent conductive performance, while its SEM images and permeability also show excellent performance. The contact angle of the substrate is an indicator used to characterize the hydrophilicity or hydrophobicity of the surface structure or coating, representing the magnitude of the interaction force between solid and liquid molecules, that is, the magnitude of the surface tension where water droplets are covered on the substrate or coating surface. As shown in FIG. 5, it is a schematic diagram of the characterization of the hydrophilicity/hydrophobicity of the conductive porous carbon paper base membranes (CP-0, CP-200, CP-400, CP-500, CP-600, CP-700) obtained with a polypyrrole deposition concentration of 0.15 mol/L corresponding to different deposition cycle layers. It can be seen from the figure that as the polypyrrole intermediate layer is deposited, the substrate becomes increasingly hydrophilic. This is because the polypyrrole chains contains a large number of N atoms, and the increase of —SO₃ groups from the dopant SDBS added during the deposition process also enhances the hydrophilicity of the substrate. A more hydrophilic substrate or intermediate layer is conducive to forming a polyamide layer with higher crosslinking degree and improved structural integrity.

Zeta potential reflects the positive or negative charge and quantity on the surface of the solid membrane. As shown in FIG. 6, it is the Zeta potential of the membrane surface of the conductive porous carbon paper base membranes (CP-0, CP-200, CP-400, CP-500, CP-600, CP-700) obtained with a polypyrrole deposition concentration of 0.15 mol/L corresponding to different deposition cycle layers. It can be seen that the CP-0 base membrane exhibits stable positively charged characteristic. As the polypyrrole intermediate layer is deposited, the surface of the conductive porous carbon paper base membrane exhibits negatively charged characteristic. Simultaneously, due to the introduction of the dopant SDBS, the increase of —SO₃ groups further strengthens the negative charge on the membrane surface.

The surface roughness characteristics of the base membrane not only play a key role in the surface structure composition but also have an important impact on the formation of the polyamide layer during interfacial polymerization, thereby affecting the separation and permeability of the composite membrane. As shown in FIGS. 7a-7f, they are atomic force microscopy images of conductive porous carbon paper base membranes (CP-0, CP-200, CP-400, CP-500, CP-600, CP-700) obtained with a polypyrrole deposition concentration of 0.15 mol/L corresponding to different deposition cycle layers. Table 2 lists the specific parameters of the surface roughness of these base membranes. It can be seen that as the polypyrrole deposition cycle number increases, the roughness of the base membrane first decreases and then increases. This is because the uniform deposition of polypyrrole covers the rough large pores of the conductive porous carbon paper base membrane, reducing the amplitude of pore size fluctuations and thereby lowering the surface roughness.

TABLE 2
Roughness Parameters of Base Membrane Surfaces

| Base Membrane | R~a~ (nm) | R~q~ (nm) |
|---|---|---|
| CP-0 | 819.2 ± 35.2 | 1027.4 ± 38.6 |
| CP-200 | 570.2 ± 29.4 | 717.8 ± 31.7 |
| CP-400 | 406.8 ± 7.8 | 532.9 ± 12.6 |
| CP-500 | 224.1 ± 9.6 | 282.3 ± 18.1 |
| CP-600 | 158.4 ± 4.3 | 197.8 ± 15.4 |
| CP-700 | 207.8 ± 2.3 | 291.5 ± 17.9 |

### R~a~represents: Average Surface Roughness; R~q~represents: Root Mean Square Roughness.

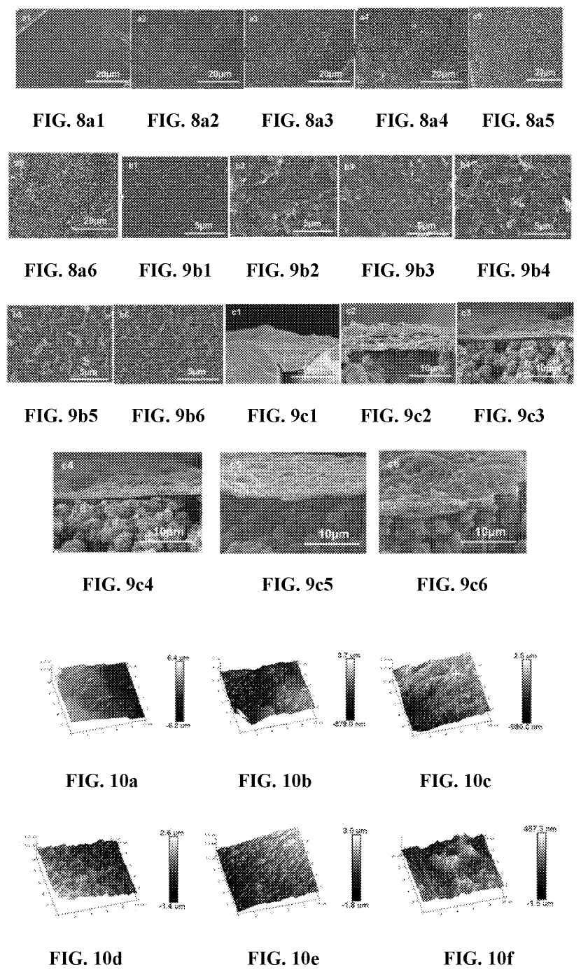

FIGS. 8a1-9c6 show surface and cross-sectional schematic diagrams of FO membranes formed on pure CP base membranes compared with conductive FO membranes obtained by adding intermediate layers of polypyrrole at different concentrations in different embodiments of the present application. FIGS. 8a1-8a6 and 9b1-9b6 are surface images of the conductive FO membranes CPFO₀, CPFO₂₀₀, CPFO₄₀₀, CPFO₅₀₀, CPFO₆₀₀, CPFO₇₀₀ formed on base membranes with different concentrations and different deposition cycle numbers of polypyrrole. FIGS. 8a1-8a6 are surface image schematics of conductive FO membranes formed on base membranes with a polypyrrole deposition concentration of 0.1 mol/L at different deposition cycle numbers. FIGS. 9b1-9b6 are surface image schematics of conductive FO membranes formed on base membranes with a polypyrrole deposition concentration of 0.15 mol/L at different deposition cycle numbers. From the figures, it can be seen that the polyamide layer formed on the CP-0 base membrane without a deposited polypyrrole intermediate layer exhibits a smooth morphology, not a ridge-and-valley morphology, due to the large pores and hydrophobic characteristics of the conductive porous substrate. This is mainly because the large pores and hydrophobic characteristics of the conductive porous carbon paper base membrane slow the diffusion rate of the m-phenylenediamine aqueous phase stored in the membrane pores, and the amount of amine monomer adsorbed on the base membrane surface is limited. When the polypyrrole intermediate layer is deposited, continuous, defect-free polyamide layers with obvious ridge-and-valley structures are formed on the conductive porous carbon paper base membranes, and they show increasingly larger leaf-like structures. This is because, on one hand, the successful deposition of polypyrrole reduces the large pores of the base membrane, compensating for the large pore defects, making the surface morphology of the base membrane flatter and more uniform, thus forming a flawless polyamide layer. On the other hand, the deposition of the polypyrrole intermediate layer changes the physicochemical properties of the base membrane surface—the increased hydrophilicity of the substrate adsorbs more amine monomers, which is conducive to the interfacial polymerization reaction, forming a more pronounced ridge-and-valley structure. From FIGS. 9c1-9c6, the cross-sectional morphology of the conductive FO membrane provided by the present application can be seen. From the membrane without the deposited polypyrrole intermediate layer, it can be seen that the formed polyamide layer is discontinuous and has a collapsed morphology. After depositing polypyrrole on the conductive porous carbon paper base membrane, continuous polyamide layers are formed on the CPFO₂₀₀, CPFO₄₀₀, CPFO₅₀₀, CPFO₆₀₀, and CPFO₇₀₀ membranes, and the thickness increases from 260 nm to 560 nm. This is because as the deposition time increases, the hydrophilicity of the deposited polypyrrole intermediate layer increases, giving m-phenylenediamine a stronger adsorption force to the substrate, thereby increasing the availability of m-phenylenediamine during the interfacial polymerization process and forming a thicker polyamide layer. On the other hand, as the intermediate layer is deposited, the roughness and pore size of the base membrane gradually decrease, allowing m-phenylenediamine to be distributed more continuously and uniformly on the base membrane, leading to an increase in the thickness of the polyamide layer.

FIGS. 10a-10f show surface AFM images of conductive FO membranes CPFO₀, CPFO₂₀₀, CPFO₄₀₀, CPFO₅₀₀, CPFO₆₀₀, and CPFO₇₀₀ formed on base membranes with a polypyrrole deposition concentration of 0.15 mol/L at different deposition cycle numbers. In the embodiment of the present application, AFM was used to determine the roughness of the prepared conductive FO membranes with the same polypyrrole deposition concentration but different deposition times. From the figures and combined with Table 3, it can be seen that the average surface roughness R~a~(nm) of CPFO₀, CPFO₂₀₀, CPFO₄₀₀, CPFO₅₀₀, CPFO₆₀₀, and CPFO₇₀₀ membranes is 380.6±16.8, 257.4±10.4, 209.5=11.3, 171.4±6.9, 107.8±7.4, 164.8±6.5 nm, respectively, and the root mean square roughness R~q~(nm) is 452.4±26.7, 354.8±24.6, 269.9=20.3, 269.0±16.2, 134.0=19.0, 205.8±20.3 nm, respectively. The roughness of the conductive FO membranes exhibits a trend of first decreasing and then increasing. Because the deposited polypyrrole cannot completely cover the rough carbon fiber surface of the conductive porous carbon paper base membrane, the surface roughness of the CPFO₀ membrane is the highest. The surface roughness of CPFO₂₀₀, CPFO₄₀₀, CPFO₅₀₀, CPFO₆₀₀, and CPFO₇₀₀ membranes after depositing conductive polypyrrole at different cycle layers in the present application is significantly lower than that of CPFO₀, and the surface roughness of membranes formed at different cycle layers is different. As the polypyrrole intermediate layer is deposited, the rough carbon fiber surface is completely covered. The roughness of CPFO₆₀₀ and CPFO₇₀₀ membranes shows an increasing trend because the formed polypyrrole intermediate layer has high hydrophilicity, sufficient to increase the reactivity of m-phenylenediamine and trimesoyl chloride, so the roughness shows an increasing trend.

TABLE 3
Roughness of Conductive FO Membrane Surfaces

| Membrane | R~a~ (nm) | R~q~ (nm) |
|---|---|---|
| CPFO₀ | 380.6 ± 16.8 | 452.4 ± 26.7 |
| CPFO₂₀₀ | 257.4 ± 10.4 | 354.8 ± 24.6 |
| CPFO₄₀₀ | 209.5 ± 11.3 | 269.9 ± 20.3 |
| CPFO₅₀₀ | 171.4 ± 6.9 | 269.0 ± 16.2 |
| CPFO₆₀₀ | 107.8 ± 7.4 | 134.0 ± 19.0 |
| CPFO₇₀₀ | 164.8 ± 6.5 | 205.8 ± 20.3 |

### R~a~represents: Average Surface Roughness; R~q~represents: Root Mean Square Roughness.

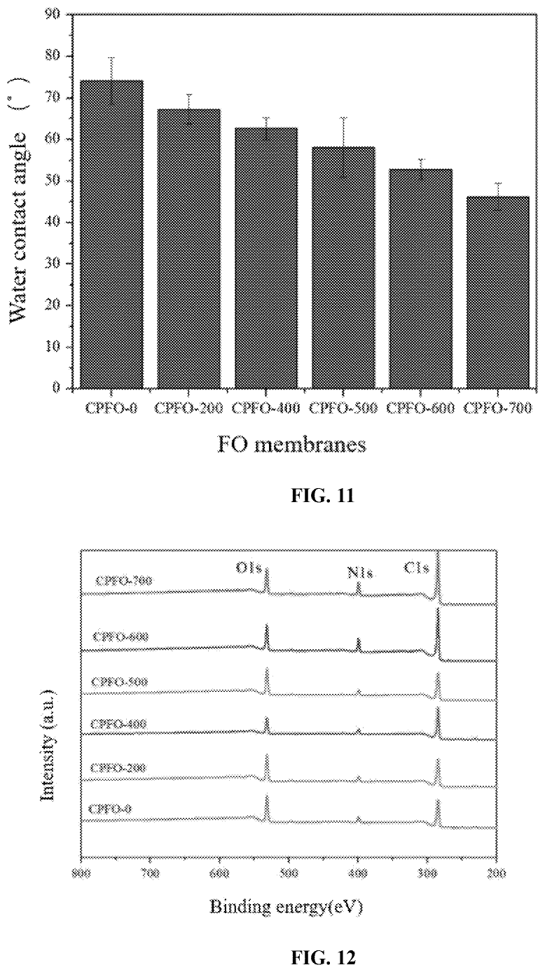

FIG. 11 is a schematic diagram of the contact angles of a comparative FO membrane formed on a pure conductive porous carbon paper substrate and FO membranes obtained by adding an intermediate layer of polypyrrole deposited with the same concentration but different cycle numbers in different embodiments of the present application. It can be seen that the FO membranes prepared on the base membrane with the deposited polypyrrole intermediate layer exhibit increasingly hydrophilic characteristics. This is because the strong hydrophilicity exhibited by the deposition of the polypyrrole intermediate layer adsorbs more m-phenylenediamine to react with trimesoyl chloride, generating more polyamide layer. The polyamide layers contain hydrophilic amino groups, so the conductive FO membrane also shows enhanced hydrophilicity.

X-ray spectrometer was used to analyze the comparative FO membrane formed on the pure conductive porous carbon paper substrate and the FO membranes obtained by adding an intermediate layer of polypyrrole deposited with the same concentration but different cycle numbers in different embodiments of the present application (FIG. 12). Table 4 shows the composition content and ratios of various elements on the surface of the prepared conductive FO membranes. Combining FIG. 12 and Table 4, it can be seen that oxygen atom peak O1s, nitrogen atom peak N1s, and carbon atom peak C1s were found in the conductive FO membranes prepared under different conditions, proving the successful formation of the polyamide layer on the base membrane. The crosslinking degree of the polyamide layer formed on the base membrane without the deposited polypyrrole intermediate layer is 46.24%. At this time, the formed polyamide layer has a loose structure, very low crosslinking degree with the substrate, and poor selectivity. As the polypyrrole deposition time increases, the N1s content value also increases, which also indicates an increase in the crosslinking degree of the polyamide layer to a certain extent. The experimental results of the embodiments of the present application indicate that this is greatly related to the deposited polypyrrole intermediate layer. The increase in the amount of polypyrrole deposition causes the substrate to aggregate and adsorb more aqueous phase-amine monomers. The results show that the high hydrophilicity of the substrate provides a concave liquid surface and continuous smaller surface pores, which provide a larger reaction area for the interfacial polymerization reaction, thus forming a continuous, highly selective active layer and producing a higher local crosslinking degree.

TABLE 4
Percentages of Different Elements and Crosslinking
Degree of Conductive FO Membranes

| | Atomic Percentage of Different | | | | |
|---|---|---|---|---|---|
| FO | Elements (%) | | | O/N | Crosslinking |
| Membrane | C | O | N | Ratio | Degree (%) |
| CPFO₀ | 72.71 | 16.09 | 11.20 | 1.44 | 46.24 |
| CPFO₂₀₀ | 73.72 | 14.65 | 11.63 | 1.26 | 65.53 |
| CPFO₄₀₀ | 74.07 | 14 | 11.93 | 1.17 | 76.05 |
| CPFO₅₀₀ | 74.17 | 13.75 | 12.08 | 1.14 | 80.60 |
| CPFO₆₀₀ | 74.36 | 13.45 | 12.19 | 1.10 | 85.26 |
| CPFO₇₀₀ | 74.10 | 13.62 | 12.28 | 1.11 | 85.48 |

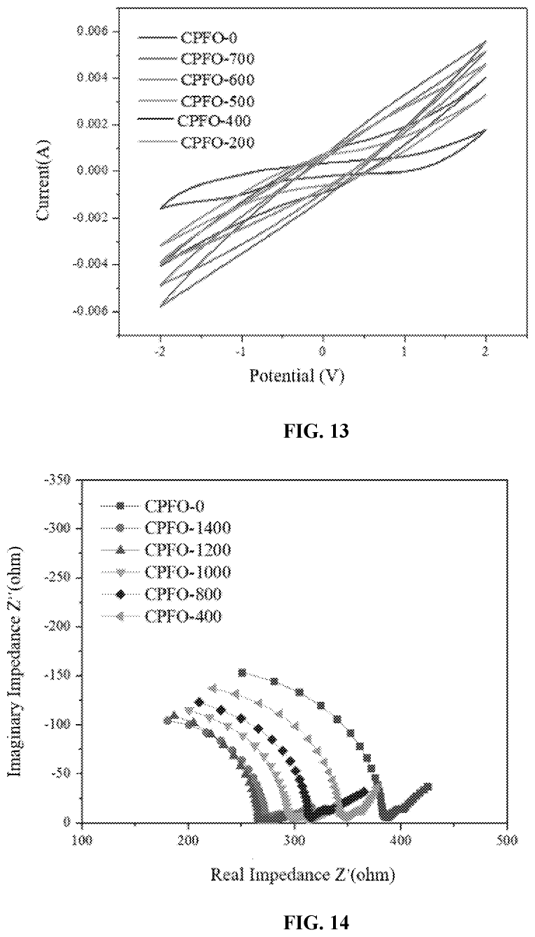

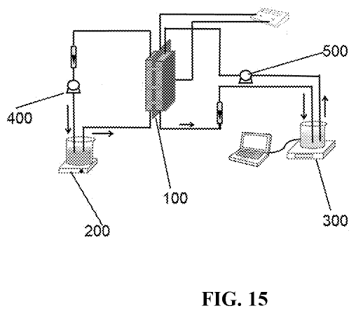

Electrochemical characterization is a fundamental and important conductivity performance indicator for conductive composite membranes, including cyclic voltammetry curve scanning (FIG. 13) and electrochemical impedance spectroscopy (EIS) testing (FIG. 14). From the figures, it can be seen that the current of the original base membrane is very stable under the scanning voltage from −2 V to +2 V, with a narrow and thin shape, and almost no redox trend within the current range from −2 V to +2 V, showing good stability in redox aspects. The cyclic voltammetry curves of the conductive FO membranes with the deposited polypyrrole intermediate layer show higher current density than the CPFO₀ membrane from −2 V to +2 V, and the current density increases with the number of deposition cycles. This is attributed to the high electron transfer rate within the conductive membrane after polypyrrole deposition, where polypyrrole tightly envelops the carbon fibers to form bridging structures. This result is also consistent with the EIS test results. EIS shows that as the deposition cycle number increases, the impedance of the conductive FO membrane gradually decreases, further confirming the excellent conductivity of the conductive FO membrane. The following tests the performance of the conductive FO membrane of the present application. FIG. 15 shows the conductive cross-flow FO device used in the present application to test the permeation selectivity of the FO membrane. During testing, no voltage is applied. The effective membrane area of the conductive FO membrane 100 in the membrane cell is 15 cm². Deionized water is used as the feed solution and placed on the stirring device 200, while sodium chloride solution is used as the draw solution and placed on the balance 300. Two peristaltic pumps 400, 500 are used to circulate the feed solution and draw solution, respectively. During operation, the temperatures of the feed solution and draw solution are controlled at 25° C., and the speed of the peristaltic pumps is 9.8 cm/s.

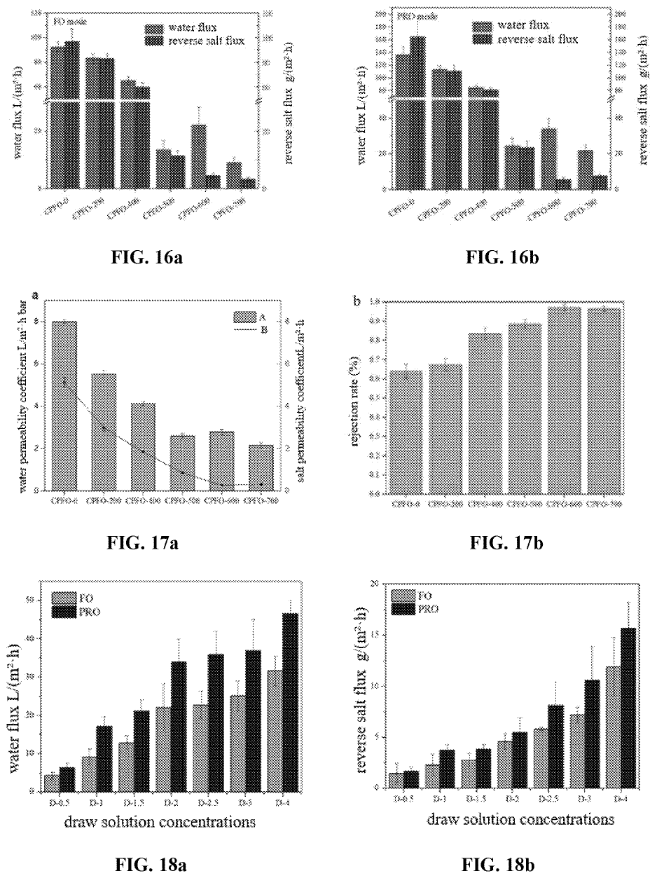

FIGS. 16a-16b show the evaluation of the performance under FO mode and PRO mode for the comparative FO membrane formed on the pure conductive porous carbon paper substrate and the FO membranes obtained by adding an intermediate layer of polypyrrole deposited with the same concentration but different cycle numbers in different embodiments of the present application. From the figures, it can be seen that the FO membrane prepared using the original conductive porous carbon paper substrate as the base has poor FO performance. The conductive FO membranes after depositing the polypyrrole intermediate layer show excellent FO performance. When the deposition cycle number is 600, the FO performance of the conductive FO membrane reaches the optimum, with water flux in FO/PRO mode of 21.09/33.96 L/(m²·h) and reverse salt flux of 4.61/5.48 g/(m²·h), respectively. When the polypyrrole deposition cycle number is 700, the flux is 9.9/21.7 L/(m²·h) and the reverse salt flux is 7.71/3.38 g/(m²·h). This is because: the higher hydrophilicity of the polyamide layer provides a larger pathway for water passage, thus showing higher water flux. The increase in hydrophilicity gives the amine monomer a stronger adsorption force to the base membrane, allowing it to store more amine monomer for interfacial polymerization reaction to generate more amide bonds, which is conducive to the increase of crosslinking degree. A higher crosslinking degree means more amide bonds are generated in the polyamide layer, making the polyamide layer denser, thus exhibiting lower reverse salt flux. The performance improvement is partly because the deposition of the polypyrrole intermediate layer fills the rough carbon fiber surface, improves the hydrophobic interface characteristics, compensates for macropore defects, and reduces porosity. The reduction in the roughness of the intermediate layer allows the m-phenylenediamine aqueous solution during interfacial polymerization process to uniformly cover the intermediate layer, making the formed polyamide layer more continuous and less prone to detachment. The improvement of macropore defects prevents the collapse of the polyamide layer, and the micropore structure facilitates the formation of a continuous, defect-free polyamide layer with a distinct leaf-like structure. The FO process where the active layer (polyamide) of the FO membrane faces the feed solution and the porous support layer (base membrane) faces the draw solution is interpreted as AL-FS mode (also called FO mode). The FO process where the active layer (polyamide layer) of the FO membrane faces the draw solution and the porous support layer (base membrane) faces the feed solution is interpreted as AL-DS mode (also called PRO mode).

FIGS. 17a-17b show the pure water flux A value and salt permeability coefficient B value schematic (FIG. 17a) and the salt rejection rate schematic (FIG. 17b) for the comparative FO membrane formed on the pure conductive porous carbon paper substrate and the FO membranes obtained by adding an intermediate layer of polypyrrole deposited with the same concentration but different cycle numbers in different embodiments of the present application. In the figure, the pure water flux (A value) and salt permeability coefficient (B value) of CPFO₂₀₀, CPFO₄₀₀, CPFO₅₀₀, CPFO₆₀₀, CPFO₇₀₀ membranes show a trend of first decreasing and then increasing. As the polypyrrole intermediate layer is deposited on the CP membrane, the structure of the polyamide layer becomes more perfect and the crosslinking degree increases. The increase in the crosslinking degree of the polyamide layer has a positive impact on the rejection rate. A higher crosslinking degree means that the formed polyamide layer has more amide bonds, thus exhibiting a higher rejection rate and salt permeability coefficient. From the above, it can be seen that the conductive FO membrane with the added polypyrrole intermediate layer has better FO filtration performance.

FIGS. 18a-18b show the water flux schematic (18a) and reverse salt flux schematic (18b) for the membrane with a polypyrrole deposition cycle number of 600 at different draw solution concentrations. In both operation modes of the FO membrane, the water flux of the FO membrane increases as the NaCl draw solution concentration increases, and the reverse salt flux also rises simultaneously. This is mainly because for the same salt solution, a higher salt solution concentration leads to higher osmotic pressure. While the osmotic pressure increases, the flux also increases. A higher draw solution concentration difference causes more salt to penetrate into the feed solution, resulting in an increase in reverse salt flux. In the figure, draw concentration represents the draw solution concentration, Water flux represents water flux, and Reverse salt flux represents reverse salt flux.

In the embodiments of the present application, by depositing a conductive polymer such as a polypyrrole intermediate layer on a hydrophobic, macropore conductive porous substrate and then performing an interfacial polymerization reaction to prepare a conductive composite FO membrane, the conductive porous base membrane has excellent conductivity, smooth surface structure, and nanoscale filtration performance, providing a good foundation for the preparation of a perfect selective layer.

In the embodiments of the present application, the deposition concentration of the polypyrrole intermediate layer is preferably 0.1-0.2 mol/L, more preferably 0.15 mol/L. The polypyrrole intermediate layer at this concentration has excellent conductive performance (minimum sheet resistance reaches 156.4 m (2/sq), smooth surface structure, and nanoscale filter performance; when using an initial pyrrole concentration of 0.15 mol/L for the intermediate layer, the deposition cycle number is preferably 600. The prepared CPFO₆₀₀ membrane has optimal performance, with water flux and reverse salt flux in FO/PRO operation mode of 33.96/21.09 L/(m²·h) and 5.48/4.61 g/(m²·h), respectively. It also has optimal electrochemical reaction activity and minimal impedance.

When using an initial pyrrole concentration of 0.15 mol/L to deposit the conductive intermediate layer, as the deposition cycle number increases, the thickness and integrity of the selective layer also gradually increase, and the crosslinking degree shows a trend of first increasing and then decreasing.

The conductive FO membrane of the present application has good conductivity, strong filtration performance, fouling resistance, and high stability.

In the present application, the conductive porous substrate can also be conductive carbon fiber or conductive paper.

In the present application, the conductive material of the conductive intermediate layer can also be negatively charged, hydrophilic conductive material such as polyaniline.

The polyamide layer formed on the original conductive porous substrate has a smooth morphology but not a ridge-and-valley morphology; after depositing the intermediate layer, the defects of the rough macropores of the conductive porous carbon paper base membrane are compensated. The hydrophilicity, roughness, pore size, electrochemical characteristics, and a series of other physicochemical properties of the membrane surface change, forming a new substrate morphology that affects the morphology and performance of the polyamide layer. High hydrophilicity, reasonable small pore size, and uniform roughness provide greater reactivity and contact area for the interfacial polymerization reaction, resulting in higher crosslinking degree and excellent FO performance.

The following further describes the present application in detail through specific embodiments.

### Example 1

A conductive FO membrane was prepared according to the following steps:
(1) Cut the purchased 10×10 cm conductive porous carbon paper substrate to a size of 5×10 cm, soak in a 0.2 mol/L NaOH solution in a petri dish for 2 hours to enhance the bonding ability between the polypyrrole intermediate layer and the CP membrane. After soaking, continue soaking and rinsing with deionized water until neutral.
(2) Fully dissolve 10.35 mL (0.15 mol/L) of pyrrole solution, 3.0 mL of ethylene glycol, 3.0 mL of oxalic acid, and 13.40 g of sodium dodecyl benzene sulfonate in 500 mL of deionized water. Separately, measure 16.1 mL of concentrated sulfuric acid (98%) with a measuring cylinder and completely dissolve it in 500 mL of deionized water. Finally, mix the two solutions in a reactor and immediately proceed with polymerization using a three-electrode system. The working electrode is the pretreated conductive porous carbon paper base membrane, the auxiliary electrodes are two titanium meshes of the same size as the CP membrane, the working electrode is placed between the two auxiliary electrodes, the reference electrode is a saturated calomel electrode (SCE), and the distance between them is 1.5 cm. Immerse all four electrodes completely in the electrochemical polymerization solution. Place the reactor in a stainless steel basin on a magnetic stirrer, set the stirring speed to 50 RPM, and surround the reactor with ice packs to maintain the temperature around 5° C. The electrochemical polymerization mode is cyclic voltammetry (CV), with a voltage scan range of −0.2 V to 0.9 V, a scan rate of 0.05 V/S, and the cycle number set to 200 cycles.
(3) Dissolve m-phenylenediamine (MPD) at a mass percentage of 3.0 wt % in 50 ml of deionized water in a brown bottle and sonicate for 30 min to obtain the m-phenylenediamine aqueous solution; dissolve trimesoyl chloride (1,3,5-benzenetricarbonyl chloride (TMC)) at a mass percentage of 0.15 wt % in 50 ml of n-hexane solvent and sonicate for 30 minutes to dissolve it completely to obtain the trimesoyl chloride organic phase solution.
(4) Place the prepared modified conductive porous carbon paper base membrane flat on a clean glass plate and fix it with a stainless steel plate frame and a rubber ring for leakage prevention. Place the conductive porous carbon paper base membrane after deposition of the intermediate layer on the glass plate with the intermediate layer facing upward.
(5) Pour the prepared 50 ml of m-phenylenediamine aqueous solution into the frame to soak the conductive porous carbon paper base membrane for 5 minutes, then pour off the excess aqueous solution and remove the stainless steel plate frame and rubber ring to obtain a pretreated membrane.
(6) Roll a rubber roller over the surface of the pretreated membrane.
(7) Pour the prepared 50 ml of trimesoyl chloride organic solution into the frame, react for 2 minutes, then pour off the excess organic solution; obtain a preliminary FO membrane with an interfacial polymerization reaction selective layer.
(8) Air-dry the obtained preliminary FO membrane naturally for 60 s, then place it in an oven to cure for 5 minutes, to obtain a conductive FO membrane with a selectively permeable polyamide layer.
(9) Store the prepared conductive FO membrane with the polyamide layer in deionized water at 4° C. until testing.

The pore diameter of the base membrane in the FO membrane prepared in the above example is as shown in FIG. 2f and Table 1, with the average pore diameter mostly distributed around 110 μm. As shown in FIGS. 16a, 16b, and Table 4, using deionized water as the feed solution and NaCl aqueous solution as the draw solution, with the crossflow rates and temperatures of both the feed and draw solutions controlled at 9.8 cm/s and 25° C., respectively. Tests show that the crosslinking degree of the FO membrane prepared in the above example is 65.53%, the water contact angle is around 67°, the water flux is 83.4 L/m²·h, the reverse salt flux is 82.7 g/m²·h, the water permeability coefficient A value is 5.51 L/m²·h/bar, the salt permeability coefficient B value is 2.82 L/m²·h, and the salt rejection rate is 68%.

The FO membrane thus prepared is denoted as CPFO₂₀₀ membrane.

### Example 2

Example 2 differs from Example 1 in that the cycle number for polymerizing pyrrole during the deposition of polypyrrole on the conductive porous carbon paper substrate is set to 400 cycles, with other conditions being the same as in Example 1. The FO membrane thus prepared is denoted as CPFO₄₀₀ membrane.

The pore diameter of the base membrane in the FO membrane prepared in the above example is as shown in FIG. 2g and Table 1, with the average pore diameter mostly distributed around 50.6 μm. As shown in FIGS. 16a, 16b, and Table 4, using deionized water as the feed solution and NaCl aqueous solution as the draw solution, with the crossflow rates and temperatures of both the feed and draw solutions controlled at 9.8 cm/s and 25° C., respectively. Tests show that the crosslinking degree of the FO membrane prepared in the above example is 76.05%, the water contact angle is around 63°, the water flux is 64.7 L/m²·h, the reverse salt flux is 58.2 g/m²·h, the water permeability coefficient A value is 4.1 L/m²·h/bar, the salt permeability coefficient B value is 1.9 L/m²·h, and the salt rejection rate is 82.56%.

### Example 3

Example 3 differs from Example 1 in that the cycle number for polymerizing pyrrole during the deposition of polypyrrole on the conductive porous carbon paper substrate is set to 500 cycles, with other conditions being the same as in Example 1. The FO membrane thus prepared is denoted as CPFO₅₀₀ membrane.

The pore diameter of the base membrane in the FO membrane prepared in the above example is as shown in FIG. 2h and Table 1, with the average pore diameter mostly distributed around 14.97 μm. As shown in FIGS. 16a, 16b, and Table 4, using deionized water as the feed solution and NaCl aqueous solution as the draw solution, with the crossflow rates and temperatures of both the feed and draw solutions controlled at 9.8 cm/s and 25° C., respectively. Tests show that the crosslinking degree of the FO membrane prepared in the above example is 80.60%, the water contact angle is around 58°, the water flux is 14.21 L/m²·h, the reverse salt flux is 12.07 g/m²·h, the water permeability coefficient A value is 2.74 L/m²·h/bar, the salt permeability coefficient B value is 0.81 L/m²·h, and the salt rejection rate is 88.09%.

### Example 4

Example 4 differs from Example 1 in that the cycle number for polymerizing pyrrole during the deposition of polypyrrole on the conductive porous carbon paper substrate is set to 600 cycles, with other conditions being the same as in Example 1. The FO membrane thus prepared is denoted as CPFO₆₀₀ membrane.

The pore diameter of the base membrane in the FO membrane prepared in the above example is as shown in FIG. 2i and Table 1, with the average pore diameter mostly distributed around 1.08 μm. As shown in FIGS. 16a, 16b, and Table 4, using deionized water as the feed solution and NaCl aqueous solution as the draw solution, with the crossflow rates and temperatures of both the feed and draw solutions controlled at 9.8 cm/s and 25° C., respectively. Tests show that the crosslinking degree of the FO membrane prepared in the above example is 85.26%, the water contact angle is around 52°, the water flux is 21.09 L/m²·h, the reverse salt flux is 4.61 g/m²·h, the water permeability coefficient A value is 2.85 L/m²·h/bar, the salt permeability coefficient B value is 0.26 L/m²·h, and the salt rejection rate is 98.61%.

### Example 5

Example 5 differs from Example 1 in that the cycle number for polymerizing pyrrole during the deposition of polypyrrole on the conductive porous carbon paper substrate is set to 700 cycles, with other conditions being the same as in Example 1. The FO membrane thus prepared is denoted as CPFO₇₀₀ membrane.

The pore diameter of the base membrane in the FO membrane prepared in the above example is as shown in FIG. 2j and Table 1, with the average pore diameter mostly distributed around 0.93 μm. As shown in FIGS. 16a, 16b, and Table 4, using deionized water as the feed solution and NaCl aqueous solution as the draw solution, with the crossflow rates and temperatures of both the feed and draw solutions controlled at 9.8 cm/s and 25° C., respectively. Tests show that the crosslinking degree of the FO membrane prepared in the above example is 85.48%, the water contact angle is around 46°, the water flux is 9.9 L/m²·h, the reverse salt flux is 7.71 g/m²·h, the water permeability coefficient A value is 2.23 L/m²·h/bar, the salt permeability coefficient B value is 0.31 L/m²·h, and the salt rejection rate is 97.53%.

The present application controls the pore size and hydrophilicity/hydrophobicity of the conductive porous carbon paper base membrane by electrochemically depositing a polypyrrole intermediate layer. Through the interfacial polymerization (IP) process, a non-collapsing and continuous polyamide layer is formed, thereby preparing a conductive FO membrane. Its performance in algae-water separation was tested. The conductive FO membrane was characterized and analyzed by scanning electron microscopy, solid surface zeta potential meter, X-ray photoelectron spectroscopy, etc. The performance and structure of the conductive FO membrane provided by the present application are mainly as follows: selective layer thickness of 260 nm-560 nm; crosslinking degree of 46.24%-85.48%; water contact angle of 46°-74°, wherein the water contact angle of the base membrane part is 29°−88°; zeta potential of −25 mV −5 mV; in FO mode, the maximum water flux of the conductive FO membrane can reach 92 L/m²·h, and the minimum reverse salt flux is 4.61 g/m²·h; in PRO mode, the maximum water flux of the conductive FO membrane is 135.08 L/m²·h, and the minimum reverse salt flux is 0.58 g/m²·h; salt rejection rate can reach 97%-98.6%. The results show that the polypyrrole intermediate layer at an appropriate cycle number under the preferred concentration can well regulate the conductive porous carbon paper base membrane and prepare conductive FO membranes with excellent separation performance.

### Application Example 1

In another aspect, the present application provides an application of the conductive FO membrane using the conductive base membrane of the present application. The conductive FO membrane of the present application can be used for treating algal liquid/algal water and can also be used for treating other sewage and waste liquids. The following is an application description of the conductive FO membrane of the present application. In the application of FO membrane technology, membrane fouling has always been a challenge that is difficult to completely solve. Other researchers have conducted many anti-fouling studies, such as modifying the surface charge of the PA layer, modifying the support layer of the composite membrane, and pretreating pollutants. However, these methods have complex preparation processes and may introduce new pollution sources. The present application proposes using a conductive composite FO membrane with an applied voltage to separate algal water. The following describes the FO algal water treatment method and FO algal water treatment system using the conductive FO membrane of the present application for algal water separation by selecting the PRO mode with relatively large membrane flux, respectively explaining the influence of electric field strength, individual/mixed algal water components, co-existing substances in water on membrane fouling, and the removal efficiency of undesirable metabolites (MC-LR, GSM, 2-MIB) in algal water, and the stability of the conductive composite FO membrane during long-term multi-cycle operation.

The present application also provides an FO method and system for treating algal water separation using the conductive FO membrane of the present application, comprising the conductive FO membrane, and wherein a negative voltage is applied during the treatment process or in the system. Further, the conductive FO membrane is the FO membrane provided by the present application, and the negative voltage is −4.0 V −0 V (excluding 0 V), further −0.5 V, −1.0 V, −1.5 V, −2.0 V, −2.5 V, −3.0 V, −4.0 V.

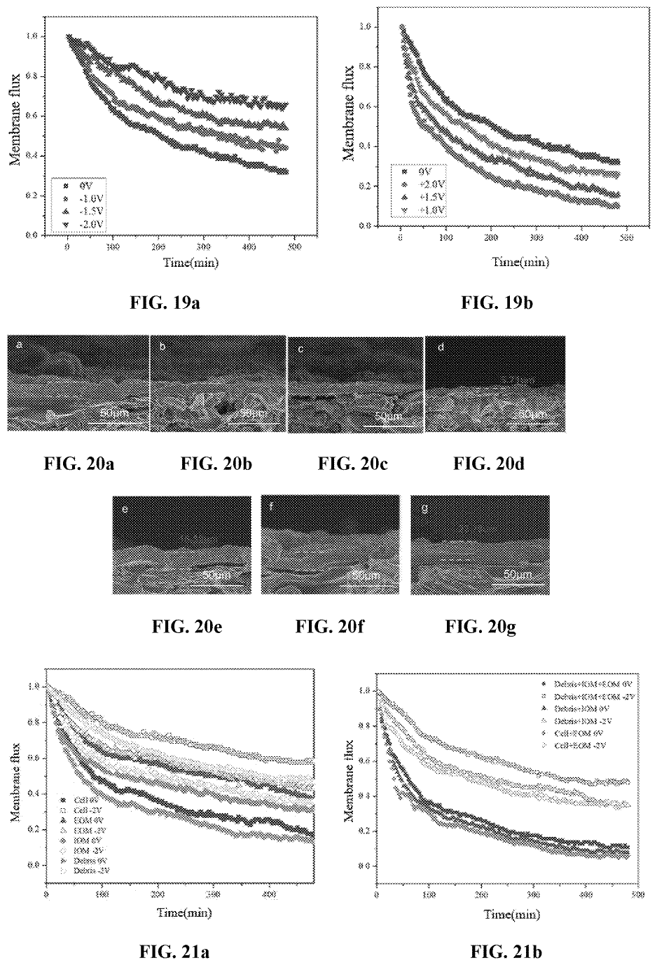

FIGS. 19a-19b are schematic diagrams of the membrane flux change of the conductive FO membrane in the application examples of the present application under different applied voltages, where FIG. 19a applies a negative voltage and FIG. 19b applies a positive voltage. From FIG. 19a, it can be seen that without an external electric field, the flux decreases by 64% after continuously treating algal water for 8 h. This is mainly because during the treatment of algal water, a large number of algal cells and extracellular polymeric substances deposit and adhere to the surface of the conductive FO membrane and enter the membrane pores, thus blocking the surface pores of the conductive FO membrane and causing severe membrane fouling, leading to a decrease in flux. When a negative voltage is applied to the conductive FO membrane, as the magnitude of the applied negative voltage increases, the membrane flux for treating algal water decreases by 56%, 46%, and 34%, respectively. Applying-2 V voltage increases the membrane flux by 34% compared to no applied voltage because the applied negative voltage causes electrostatic repulsion with the negatively charged pollutants in the algal water, slowing down the process of pollutants adhering to the surface of the conductive FO membrane, thereby alleviating membrane fouling during algal water treatment.

FIG. 19b is a schematic diagram of membrane flux when a positive voltage is applied to the conductive FO membrane. It can be seen from the figure that when a positive voltage is applied to the CPFO, the decline trend of membrane flux for treating algal water is somewhat alleviated. When voltages of +1.0 V, +1.5 V, and +2.0 V are applied to the composite membrane, the membrane flux for treating algal water decreases by 64%, 72%, and 80%, respectively. By comparison, it can be found that when +2.0 V is applied, the flux decreases by 16% compared to no voltage. This is because the algal cells and extracellular organic matter in the algal water carry a large amount of negative charge. When a positive voltage is applied to the membrane, electrostatic attraction occurs, causing more pollutants to adhere to the membrane surface and form a thicker filter cake layer, resulting in more severe membrane fouling when a positive voltage is applied compared to no voltage.

FIGS. 20a-20g are schematic diagrams of the filter cake layer thickness cross-section of the surface of the conductive FO membrane in the embodiments of the present application under different applied voltages. The applied voltages in the figures are 0 V, −1.0 V, −1.5 V, −2.0 V, +1.0 V, +1.5 V, and +2 V, respectively. It can be seen from the figures that when a negative voltage is applied, the thickness of the filter cake layer gradually decreases from 12.56 μm without applied voltage to 5.71 μm at −2 V applied voltage. This indicates that the applied negative voltage generates electrostatic repulsion against pollutants, alleviating membrane fouling during algal water treatment. After applying a positive voltage, the filter cake layer thickness gradually increases with the increase of applied voltage compared to no applied voltage. This is because applying a positive voltage generates electrostatic attraction to pollutants, causing more pollutants to adhere to the membrane surface, aggravating membrane fouling during algal water treatment.

FIGS. 21a-21d are schematic diagrams showing the effect of individual and mixed algal water components on membrane performance for the conductive FO membrane in the application examples of the present application under different applied voltages. Among them, 21a and 21b are flux change schematics, 21c is a flux recovery rate schematic, and 21d represents membrane resistance schematic. In FIG. 21a, in the case of individual algal water components, without applied voltage, the flux decline of algal intracellular organic matter (IOM) is greater than that of extracellular organic matter (EOM). The final specific fluxes of IOM and EOM after 8 h of operation are 0.31 and 0.36, respectively. This is related to the composition of the two substances. Because IOM carries less negative potential than EOM and, at the same dissolved organic carbon (DOC) concentration, IOM contains more small molecules and particles, IOM is more likely to adhere to the membrane surface and clog pores, causing more severe flux decline. After applying a −2 V electric field, due to the inherent charge characteristics of EOM and IOM, the flux decline is somewhat alleviated. After 8 h of operation, the final specific fluxes of live and dead algal cells are 0.17 and 0.13, respectively. This is because compared to live algal cell solution, dead algal cell solution has a lower Zeta potential value. Therefore, dead algal cells are more likely to agglomerate and precipitate in the solution and also more likely to adhere to the composite membrane surface. Another reason is that the broken cell structure of dead algal cells has smaller molecular structures, making it easy to enter membrane pores and cause pore blockage, resulting in more severe membrane fouling. The reason why the flux decline of live and dead algal cells is faster than that of EOM and IOM is that under long-term operation conditions, algal cells are compressible. The pressure borne by the filter cake layer formed by algal cells gradually increases, and the filter cake layer is thus compressed, becoming less porous, causing rapid flux decline. When a −2 V voltage is applied, it can be observed that the fluxes of live and dead algal cells increase by 42% and 34%, respectively, compared to no applied voltage. This is because the large amount of negative charge carried by live and dead algal cells themselves causes electrostatic repulsion with the applied negative voltage, slowing down the adhesion of algal cells on the FO membrane, reducing the accumulation of pollutants on the membrane surface, thereby alleviating the membrane flux decline. The insignificant improvement in flux decline of EOM and IOM after applying voltage is because their inherent negative potential is lower, reducing the electrostatic repulsion effect (the flux increases when voltage is applied is 6% and 4%, respectively).

In the flux change diagram of mixed algal water components in FIG. 21b, it can be seen that without applied voltage, among the three mixed algal water components, the flux decline of live algal cells+EOM is the fastest, with a final specific flux of 0.08. This is because there is a synergistic interaction between live algal cells and EOM. The compressible thick filter cake layer formed by algal cells, combined with EOM continuing to fill the gaps between algal cells, forms severe composite fouling. In the presence of dead algal cells, due to the incompressibility of broken algal cells, the formed filter cake layer is thinner than that formed by live algal cells. Although organic matter also fills the gaps in the cake layer, the final specific flux is slightly higher than that of live algal cells+EOM. When a −2 V electric field is applied, it can be seen from the figure that compared to no applied voltage, the flux decline of the three mixed algal water components (live algal cells+EOM, dead algal cells+EOM+IOM, dead algal cells+IOM) is alleviated, increasing by 37%, 27%, and 29%, respectively. Because live algal cells+EOM themselves have the most negative charge, they have stronger electrostatic repulsion to reduce pollutant attachment, so they show a higher membrane flux mitigation effect than the other two mixed components when a negative voltage is applied.

FIGS. 21c and 21d are the flux recovery rate and membrane resistance schematics, respectively. From the two figures, it can be seen that after applying voltage, the flux recovery rate increases, and the reversible and irreversible resistances decrease. In the figure, the flux recovery rates after hydraulic cleaning of membranes fouled by EOM and IOM are 89.5% and 86.2%, respectively. This indicates that some organic matter from EOM and IOM adheres to the membrane surface and clogs membrane pores, resulting in irreversible fouling. Due to their inherent characteristics, IOM causes more severe irreversible fouling than EOM. The flux recovery rates after hydraulic cleaning of live and dead algal cells are 97% and 90%, respectively. This indicates that in FO membrane fouling, organic membrane foulation is the main component of irreversible fouling. Separate live and dead algal cell membrane fouling can be removed by hydraulic cleaning, and the main fouling caused is reversible fouling. Among the three mixed algal water components, the maximum flux recovery rate of live algal cells+EOM after hydraulic flushing reaches 92%, and the reversible resistance in algal water is the highest. The flux recovery rates of dead algal cells+EOM+IOM and dead algal cells+IOM after hydraulic flushing are 80.3% and 82.1%, respectively. It can be seen that irreversible fouling is intensified. Because both dead algal cells and IOM lead to increased irreversible fouling, in the case of the simultaneous presence of dead algal cells, IOM, and EOM, irreversible fouling is the most severe. Therefore, for mixed algal components, the reversibility of fouling is worse than that observed in individual algal components. Through the above application description, it can be seen that the FO membrane of the present application has strong anti-fouling properties and stability. At the same time, it can be seen that after applying a negative voltage, the membrane fouling of each membrane is reduced, and the pollutants adhering to the membrane surface are significantly reduced.

FIGS. 22a, 22a1-22g1, 22a2-22g2, 22a1′-22g1′, 22a2′-22g2′ are SEM images of the conductive FO membrane in the embodiments of the present application under different algal water components and different applied voltages. Among them, FIG. 22a is the SEM image of the original membrane surface; FIGS. 22a1-22g1 are SEM images of the membrane surface after fouling by EOM, IOM, live algal cells, dead algal cells, live algal cells+EOM, dead algal cells+IOM, dead algal cells+EOM+IOM without applied voltage, respectively; FIGS. 22a2-22g2 are SEM images of the membrane surface after fouling by EOM, IOM, live algal cells, dead algal cells, live algal cells+EOM, dead algal cells+IOM, dead algal cells+EOM+IOM with applied-2 V voltage, respectively; FIGS. 22a1′-22g1′ are cross-sectional SEM images of the membrane after fouling by EOM, IOM, live algal cells, dead algal cells, live algal cells+EOM, dead algal cells+IOM, dead algal cells+EOM+IOM without applied voltage, respectively; FIGS. 22a2′-22g2′ are cross-sectional SEM images of the membrane after fouling by EOM, IOM, live algal cells, dead algal cells, live algal cells+EOM, dead algal cells+IOM, dead algal cells+EOM+IOM with applied −2 V voltage, respectively. It can be seen from the figures that after applying a negative voltage, the membrane fouling of each membrane is reduced, and the pollutants adhering to the membrane surface are significantly reduced. The thickness of the filter cake layer on the membrane surface of the three mixed algal components decreases, alleviating the flux decline and also reducing reversible and irreversible membrane fouling. The top layer thickness in each cross-sectional image is the thickness of pollutants under different voltages.

The following explains the impact of coexisting substances in water on the conductive FO membrane in algal water separation through application examples.

The composition of natural algal water is relatively complex, containing a large amount of inorganic substances, organic substances, and inorganic particles, etc. Existing research technologies have shown that in ultrafiltration, algal cells and soluble algal products have a synergistic effect on membrane fouling in the presence of natural organic matter and inorganic particles, which will affect membrane fouling. The following application examples of the present application demonstrate the effects of coexisting inorganic substances, organic matter, and inorganic particles in algal water on the fouling of the conductive FO membrane and pollutant removal during algal water separation. This is achieved by adding Ca²⁺, HA, and kaolin to the algal water.

### Application Example 2: Effect of Algal Water with Coexisting Ca²⁺ on FO Membrane

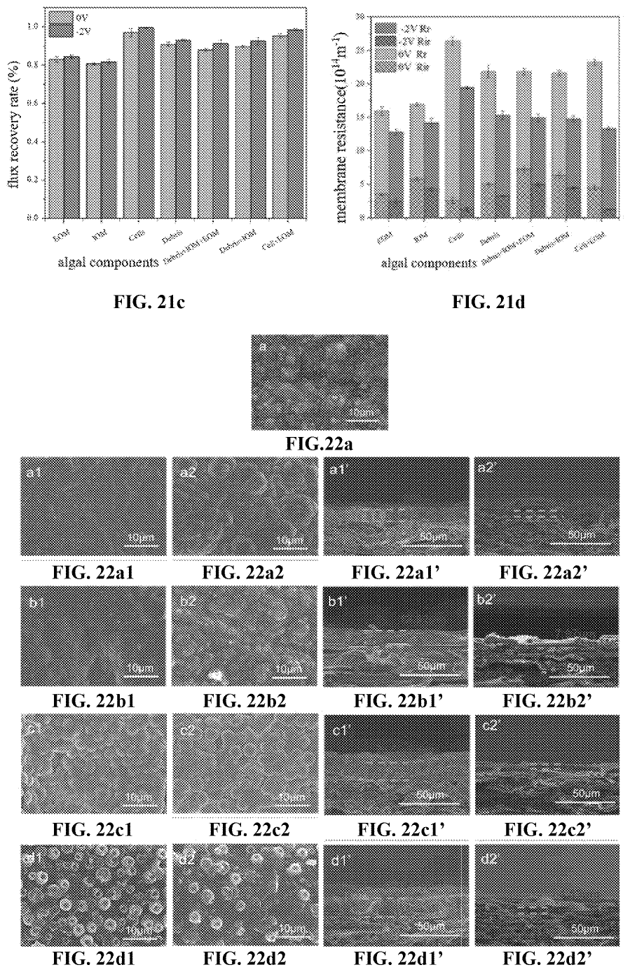

First, Ca²⁺ was added to the algal water to illustrate the fouling impact on the CPFO membrane. After each cycle of fouling experiment, the membrane was physically cleaned, and the draw solution and feed solution were replaced. From FIGS. 23a, 23b, 23c, 23d, 23e, it can be seen that in continuous multi-cycle operation, when Ca²⁺ is absent in the algal water, as the operation cycle increases, the initial flux of the 2nd, 3rd, and 4th cycles decreases by 9%, 20%, and 25%, respectively. After applying voltage, the initial flux of the 2nd, 3rd, and 4th cycles decreases by 2%, 7%, and 12%, respectively. This indicates that under applied negative voltage, long-term multi-cycle operation slows down the flux decline. The reason is the electrostatic repulsion between the CPFO membrane and the algal water reduces the adhesion of algal pollutants. When the coexisting substance Ca²⁺ is added to the algal water, as the operation cycle increases, the initial flux of the 2nd, 3rd, and 4th cycles decreases by 15%, 25%, and 37%, respectively. The reason is that Ca²⁺ promotes the binding between it and the oxygen-containing functional groups in the algal water and the algal water membrane surface. Some studies have shown that the average porosity of the gel filter cake layer formed by Ca²⁺ and algae decreases linearly with increasing Ca²⁺ concentration when exceeding a critical calcium ion concentration of 6 mmol/L (the Ca²⁺ value in this experiment is 8 mmol/L). Therefore, the combination of Ca²⁺ and algal water becomes more tightly cross-linked and denser, different from the floc filter cake layer formed in algal water without Ca²⁺. From FIGS. 23a, 23b, it can be seen that when Ca²⁺ is added, the particle size in the algal water gradually increases, forming a stable, dense cross-linked gel network, leading to increased membrane fouling and irreversible fouling. When voltage is applied to the CPFO membrane surface, the initial flux of the 2nd, 3rd, and 4th cycles decreases by 5%, 10%, and 14%, respectively. This shows that under applied negative voltage, membrane fouling can be effectively alleviated. It is found that under the same conditions, with applied negative voltage compared to without applied negative voltage, the membrane has stronger fouling resistance and stability, and the water flux decline is less.

Next is the explanation of pollutant removal. Under applied voltage, the removal rate of algal toxins by the CPFO membrane in four cycles is above 99.5%. This is because the mutual repulsion between the algal toxin molecules and the CPFO membrane surface hinders the migration of pollutants to the membrane surface, thereby increasing the removal rate. Without voltage, as can be seen from FIGS. 23a, 23b, 23c, 23d, 23e, the removal rate of algal toxins by the CPFO membrane in four cycles is lower, around 95.5%. However, when Ca²⁺ is added to the solution, the removal rate of algal toxins by the CPFO membrane is above 99.5%. This is because adsorption kinetics and isothermal experiments have shown that the presence of K⁺ or Ca²⁺ in the solution enhances the adsorption sites for microcystin adsorption, both promoting the adsorption of MC-LR in the filter cake layer, thus achieving a high rejection rate of >99.5. Regarding the removal rates of 2-MIB and GSM, from FIGS. 23d and 23e, it can be seen that in the first cycle, only under the condition of no applied voltage and with Ca²⁺ addition, the removal rate reached above 99.5%, while under other conditions, it was above 95%. In the 2nd, 3rd, and 4th cycles, it was found that the efficiency of removing 2-MIB and GSM reached above 99.5%. This is because these two pollutants themselves are not charged. Under heavy fouling conditions, the pore size screening of the dense cross-linked filter cake layer with smaller porosity formed by Ca²⁺ and algal water on the membrane surface can achieve ideal removal effects, improving the removal rate from about 95% to above 99%.

This application example shows that among the coexisting substances in water, when Ca²⁺ coexists in algal water, without applied voltage, as the operation time increases, the membrane fouling is more severe than when Ca²⁺ is absent. This is because the combination of Ca²⁺ and oxygen-containing functional groups in the algal water on the membrane surface forms a dense cross-linked fouling layer, intensifying membrane fouling. When a negative voltage is applied, in the algal water with added Ca²⁺, membrane fouling is reduced, and the flux decline is decreased. When Ca²⁺ is added to the solution, the removal rates of MC-LR, 2-MIB, and GSM reach above 99.5%: adsorption kinetics and isothermal experiments have shown that the presence of K⁺ or Ca²⁺ in the solution enhances the adsorption sites for microcystin adsorption, both promoting the adsorption of MC-LR in the filter cake layer, thus achieving a high rejection rate for MC-LR. The two pollutants 2-MIB and GSM are inherently electrically neutral, and the pore size screening of the dense cross-linked filter cake layer formed by Ca²⁺ and algal water on the membrane surface achieves ideal removal effects. Overall, under the same conditions, with applied negative voltage, the degree of membrane fouling is lower.

### Application Example 3: Effect of Algal Water with Coexisting HA on Conductive FO Membrane

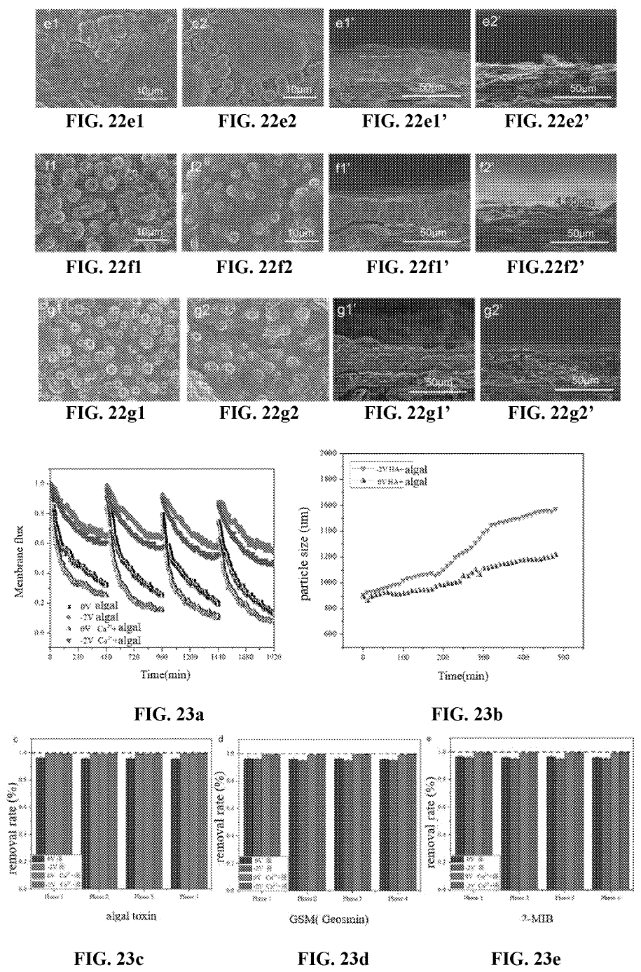

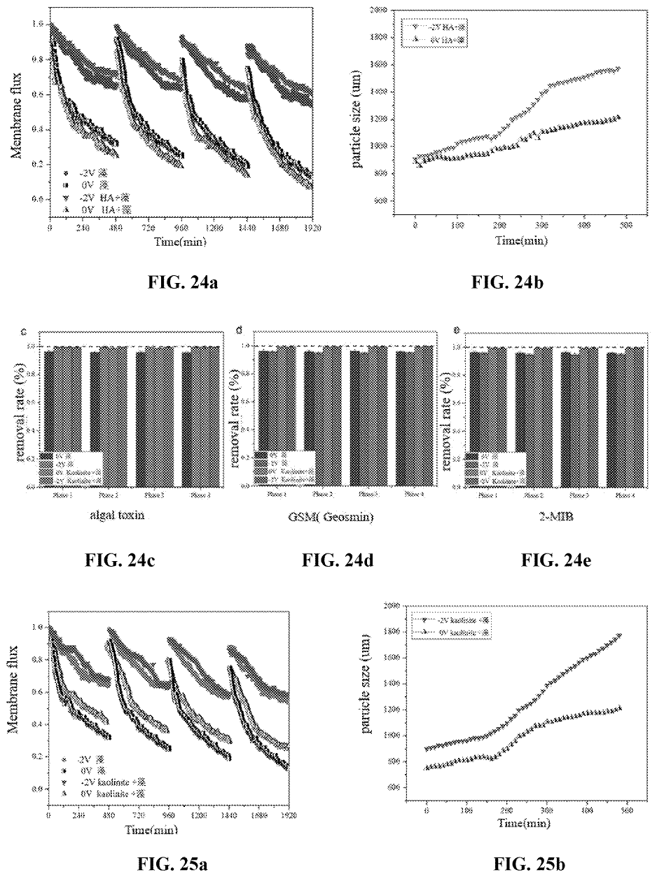

FIGS. 24a-24e show the effect of the addition of HA on the specific flux of the CPFO membrane. FIG. 24a shows the effect of HA on membrane flux;

FIG. 24b shows the effect of HA on the particle size in algal water; FIGS. 24c-24e are schematics of pollutant removal rates. It can be seen from continuous multi-cycle operation that first, when HA is absent in the algal water, as the operation cycle increases, the initial flux of the 2nd, 3rd, and 4th cycles decreases by 9%, 20%, and 25%, respectively. After applying voltage, the initial flux decline of the 2nd, 3rd, and 4th cycles is alleviated by 6%, 11%, and 10%, respectively. The reason is that under applied voltage, long-term multi-cycle operation slows down the flux decline because the electrostatic repulsion between the CPFO membrane and the algal water reduces the adhesion of algal pollutants. When the co-existing substance HA is added to the algal water, equivalent to increasing the organic matter concentration in the algal water, as the operation cycle increases, the initial flux of the 2nd, 3rd, and 4th cycles decreases by 15%, 25%, and 37%, respectively. The reason is that HA can adsorb on the EOM surface through hydrophobic interaction, enhancing the hydrophobicity of EOM, thereby increasing the irreversibility of membrane fouling. Correspondingly, from FIGS. 24a, 24b, 24c, 24d, 24e, it can be seen that when HA is added, the particle size in the algal water gradually increases over time. When a voltage is applied to the CPFO membrane surface, the initial flux of the 2nd, 3rd, and 4th cycles decreases by 5%, 10%, and 14%, respectively. This shows that under applied negative voltage, membrane fouling can be effectively alleviated. However, when voltage is applied to the CPFO membrane surface, from FIG. 24a, it is found that the presence of HA alleviates the flux decline compared to without HA addition (membrane flux alleviation is 9%). This is because the addition of HA makes the algal water fouling solution weakly acidic. Some studies have shown that current density and weakly acidic pH are conducive to the rapid formation of large flocs and porous structures, effectively reducing membrane pore blockage. This also corresponds to FIG. 24b, where the addition of HA under applied voltage causes the particle size in the algal water to gradually increase. This porous filter cake layer structure effectively alleviates membrane fouling.

In the study of pollutant removal in algal water, under applied-2V voltage, the removal rate of MC-LR by the CPFO membrane in 4 cycles is above 99.5%, which is higher than that without applied voltage. This is because under applied negative voltage, the MC-LR molecules carry a negative charge, and the electrostatic repulsion between them and the negative voltage applied to the membrane increases the removal rate of MC-LR. Without applied voltage and without HA co-existence, although the CPFO membrane surface also shows a negative charge, from the figures in the above application examples, the weak negative charge on the membrane surface cannot completely remove MC-LR in the algal water. However, when HA is added to the solution, it can be observed that the removal rate of MC-LR by the CPFO membrane in 4 cycles also reaches above 99.5%. This is due to the background effect of HA. Some studies have proven that humic substances increase the negative charge on the membrane surface, thereby strengthening the electrostatic repulsion between MC-LR molecules and the CPFO membrane, achieving a high removal rate. The removal rates of 2-MIB and GSM show different results. From FIGS. 24d, 24e, it can be seen that in the absence of HA, the removal rates of 2-MIB and GSM in 4 cycles are around 95%, which is relatively low. This may be because these two pollutants themselves are not charged and are only retained by the highly selective PA layer of the CPFO membrane. However, when HA is present in the algal water, it is found that the removal rates of 2-MIB and GSM in 4 cycles are above 99.5%. This is because 2-MIB and GSM are prone to combine with coexisting humic substances in the water (the interaction between humic substances and 2-MIB is mainly van der Waals forces and hydrogen bonds, which is consistent with HA being mainly composed of proteins, amino acids, and peptides), causing changes in the physicochemical properties of 2-MIB and altering its migration and removal behavior, thereby enhancing the removal rate.

The above application example illustrates: When HA coexists in algal water, without applied voltage, the reason for heavier membrane fouling with HA compared to algal water without HA is that HA can adsorb on the EOM surface through hydrophobic interaction, enhancing the hydrophobicity of EOM, thereby increasing the irreversibility of membrane fouling. When voltage is applied to the CPFO membrane surface, the presence of HA alleviates the flux decline compared to without HA addition (membrane flux alleviation is 9%). This is because the addition of HA makes the algal water fouling solution weakly acidic, and the weak current density generated by the applied voltage and the weakly acidic pH are conducive to the rapid formation of large flocs and porous structures, effectively reducing membrane pore blockage. When HA is added to the solution, the removal rates of MC-LR, 2-MIB, and GSM reach above 99.5% because: the background effect of HA increases the negative charge on the membrane surface, thereby strengthening the electrostatic repulsion between MC-LR molecules and the CPFO membrane, achieving a high removal rate. 2-MIB and GSM are prone to combine with co-existing humic substances in the water (the interaction between humic substances and 2-MIB is mainly van der Waals forces and hydrogen bonds), causing changes in the physicochemical properties of 2-MIB, achieving high removal rates.

### Application Example 4: Effect of Algal Water with Coexisting Kaolinite on Conductive FO Membrane

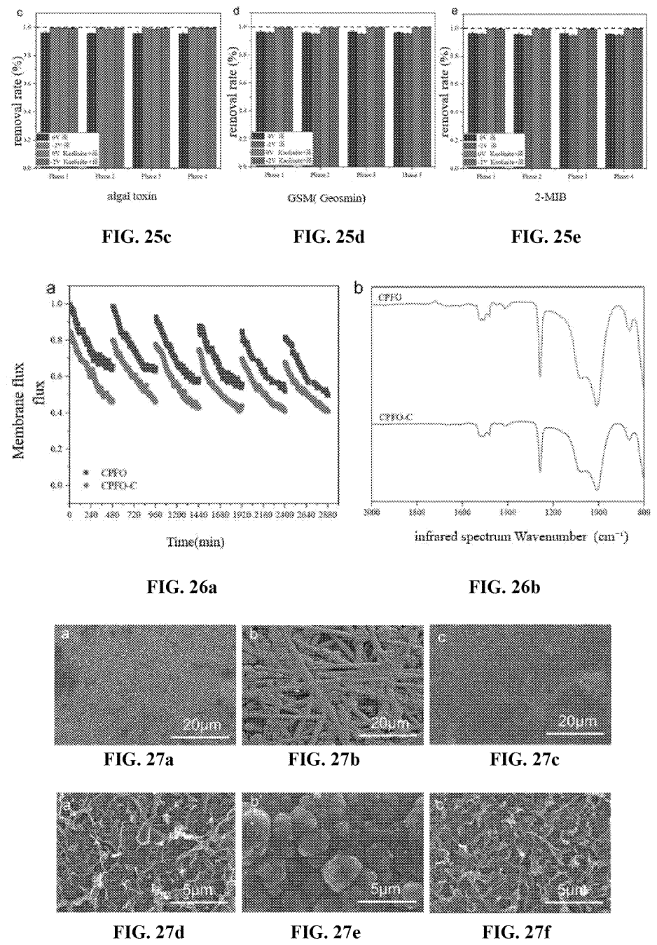

FIGS. 25a-25e show the effect of the presence of Kaolinite coexisting substance on the specific flux of the CPFO membrane. It can be seen from continuous multi-cycle operation that first, when Kaolinite is absent in the algal water, as the operation cycle increases, the flux decline under applied voltage is alleviated by 5%, 13%, and 17% compared to without applied voltage, respectively. The reason is also the electrostatic repulsion force of the CPFO membrane surface reducing the adhesion of algal pollutants. When the algal water contains Kaolinite, the initial flux of the 2nd, 3rd, and 4th cycles decreases by 10%, 18%, and 27%, respectively. This is because the presence of Kaolinite inorganic particles, with long-term operation in each cycle, the fouling layer thickness also increases, increasing the hydraulic resistance, leading to more severe external concentration polarization in the FO process, thereby aggravating membrane fouling and reducing water flux. Under applied voltage, from FIG. 25a, it is found that the flux decline with added Kaolinite is alleviated compared to without Kaolinite. This is because the current density generated by the applied voltage causes Kaolinite to produce an aluminum coagulant per unit time, thereby enhancing the aggregation of pollutants in the algal water and forming large-sized flocs (as evidenced by the data in FIG. 25b), thus alleviating membrane fouling.

In the study of pollutant removal in algal water, from FIG. 25c, it can be seen that under applied voltage, the removal rate of MC-LR by the CPFO membrane in 4 cycles is above 99.5%. However, without applied voltage, it is found that the removal rate of MC-LR in algal water with added Kaolinite clay particles (>99.5%) is higher than that without Kaolinite particles (<95%). This is because MC-LR can be enhanced for retention and filtration through clay ores with high viscosity, such as Kaolinite, which have fine-textured particles on the surface, thereby enhancing removal. Regarding the removal rates of 2-MIB and GSM, from FIGS. 25c, 25d, and 25e, it can be seen that when Kaolinite is added, the removal rates of 2-MIB and GSM in 4 cycles are above 99.5%. This is because the layered structure of Kaolinite itself has strong adsorption, enhancing the retention rate of 2-MIB and GSM by the CPFO membrane.

When Kaolinite coexists in algal water, without applied voltage, the reason for heavier membrane fouling with Kaolinite compared to without Kaolinite is that the addition of Kaolinite masks the negative charge on the surface of algal cells, thereby weakening the electrostatic repulsion with the CPFO membrane sur face and aggravating membrane fouling. When voltage is applied to the membrane surface, the membrane fouling with Kaolinite is alleviated compared to without Kaolinite (membrane flux alleviation is 7%). This is because the current generated by the applied voltage causes Kaolinite to produce an aluminum coagulant per unit time, thereby enhancing the aggregation of pollutants and forming large-sized flocs, alleviating membrane fouling. When Kaolinite is added to the solution, the removal rates of MC-LR, 2-MIB, and GSM reach above 99.5% because MC-LR can be enhanced for retention and filtration through clay ores with high viscosity, such as Kaolinite, which have fine-textured particles on the surface, thereby enhancing the removal rate. 2-MIB and GSM are due to the strong adsorption of the layered structure of Kaolinite itself for organic matter, thereby strengthening the removal efficiency.

The conductive FO membrane provided by the present application maintains strong stability during long-term multi-cycle operation.

The conductive FO membrane prepared by the present application maintains strong performance in algal water separation stability and pollutant removal ability during long-term operation. In the embodiments of the present application, a continuous 6-cycles long-term operation experiment was conducted on the prepared conductive FO membrane. To further verify that the prepared composite membrane has continuous, reusable value, after 6 cycles of operation, the PA layer of the composite membrane was peeled off, and then the PA layer was regenerated on the original conductive substrate using the interfacial polymerization method. This regenerated conductive composite base membrane was named CPFO-C. The long-term operation stability of algal water separation and pollutant removal ability of CPFO-C were further investigated. Some physicochemical properties of CPFO and CPFO-C membranes were analyzed and characterized.

To better illustrate the stability of the CPFO membrane under long-term operation conditions, after the CPFO membrane was continuously operated for 6 cycles (8 h each cycle), the surface PA layer was peeled off, and interfacial polymerization was performed again. This conductive FO membrane was named CPFO-C membrane. Then, the flux stability and pollutant removal ability of the CPFO membrane continuously operated for 6 cycles (8 h each cycle) in algal water separation were explained.

From FIGS. 26a, 26b, they show the membrane flux change during long-term operation of CPFO and CPFO-C membranes and the FT-IR spectrum of the PPy intermediate layer after peeling the PA layer of the CPFO membrane, respectively. It can be seen that compared to the CPFO membrane before peeling, the CPFO-C membrane after peeling still maintains operational stability during continuous 6-cycle long-term operation, except for the flux decline caused by irreversible membrane fouling induced by algal water in the CPFO membrane. From the infrared spectrum in FIG. 26b, it can be seen that the continuous use of the CP base membrane did not change the chemical composition of the PPy intermediate layer, and no new functional group peaks appeared. This stable base membrane property also resulted in a well-formed PA layer structure after interfacial polymerization reaction on it after peeling the original PA layer (as shown in FIGS. 27a-27f, SEM images of the CPFO membrane before and after peeling, where FIGS. 27a, 27d are SEM schematics of the PA layer of the CPFO membrane; FIGS. 27b, 27e are SEM schematics of the exposed PPy intermediate layer after peeling the PA layer; FIGS. 27c, 27f are SEM schematics of the PA layer of the CPFO-C membrane).

TABLE 4-2
Pollutant Removal Efficiency (Remove ratio) of CPFO and CPFO-C
Membranes

| Removal Efficiency | Phase 1 | Phase 2 | Phase 3 | Phase 4 | Phase 5 | Phase 6 |
|---|---|---|---|---|---|---|
| CPFO | 99.2 ± 0.5% | 99.7 ± 0.5% | 99.2 ± 0.5% | 99.7 ± 0.3% | 99.6 ± 0.3% | 99.4 ± 0.5% |
| (MC-LR, GSM, 2-MIB) | 95.4 ± 0.3% | 94.4 ± 0.2% | 95.4 ± 0.3% | 95.6 ± 0.2% | 94.8 ± 0.5% | 94.5 ± 0.2% |
| | 94.8 ± 0.4% | 95.7 ± 0.6% | 94.3 ± 0.3% | 94.8 ± 0.8% | 94.8 ± 0.4% | 95.8 ± 0.3% |
| CPFO-C | 99.7 ± 0.3% | 99.3 ± 0.6% | 98.9 ± 0.7% | 99.7 ± 0.5% | 99.5 ± 0.5% | 99.9 ± 0.2% |
| (MC-LR, GSM, 2-MIB) | 94.5 ± 0.3% | 93.8 ± 0.9% | 93.4 ± 0.7% | 92.3 ± 1.2% | 94.3 ± 0.8% | 93.4 ± 1.2% |
| | 95.8 ± 0.4% | 94.8 ± 0.4% | 93.8 ± 0.9% | 94.8 ± 0.5% | 93.8 ± 0.9% | 94.8 ± 0.9% |

Under long-term operation, it was found that before and after peeling the PA layer, the CPFO membrane, apart from a slight decrease in flux, still maintained high removal efficiency for the three pollutants. Mainly, through SEM, pollutant removal efficiency testing, and Fourier transform infrared spectroscopy, it was found that the CP base membrane still maintained stable chemical performance and composite FO performance after long-term operation. Therefore, long-term operation will not damage the physicochemical properties and performance of the CPFO membrane, and it has strong chemical practicality and durability.

Additionally, the conductive FO membrane provided by the present application is prepared by electrochemically depositing a polypyrrole intermediate layer on a conductive porous carbon paper base membrane. The deposition of the polypyrrole intermediate layer compensates for the rough large macropore defects of the conductive porous carbon paper base membrane, changing the hydrophilicity, roughness, pore size, electrochemical characteristics, and a series of other physicochemical properties of the base membrane surface. Moreover, the new morphology of the intermediate layer affects the morphology and performance of the polyamide layer. As the deposition cycle number of the polypyrrole intermediate layer increases, the conductive porous carbon paper base membrane forms a new substrate morphology. High hydrophilicity, reasonable small pore size, and uniform roughness provide greater reactivity and contact area for the reaction between m-phenylenediamine and trimesoyl chloride, resulting in a higher crosslinking degree and excellent FO performance.

Additionally, under the preferred pyrrole concentration of 0.15 mol/L and further preferred cycle number of 600 cycles in the present application, the base surface pore size of the conductive porous carbon paper base membrane is 1.08±3.4 μm, the porosity is 34.6±1.7%, and the hydrophilic contact angle is 32.4±2.31°. The conductive FO membrane prepared under these conditions has the best electrochemical activity and the lowest impedance, and the FO performance also reaches the best data: water flux and reverse salt flux under FO/PRO operation mode are 33.96/21.09 L/(m²·h) and 5.48/4.61 g/(m²·h), respectively.

Additionally, the FO membrane provided by the present application has a high removal rate for undesirable metabolites in algal water, such as algal toxins (MC-LR), geosmin (GSM), and 2-methylisoborneol (2-MIB). Under the influence of electric field strength, applying a negative voltage can greatly alleviate membrane fouling. Applying-2 V voltage increases the flux by 34% compared to no applied voltage. Regardless of whether voltage is applied, the removal rates of the three pollutants by the conductive FO membrane all reach above 95%. Among them, when a negative voltage is applied, the removal rate of MC-LR reaches above 99.5%, and the removal rates of GSM and 2-MIB are above 95%. When a negative voltage is applied, the removal rate of MC-LR reaches above 99.5%, and the removal rates of GSM and 2-MIB are above 95%.

Additionally, after applying voltage, the FO membrane provided by the present application has the best membrane flux for live algal cells+EOM in mixed algal water components, with an enhancement effect of about 37%.

Additionally, the FO membrane provided by the present application, under long-term operation, even if the polyamide layer is peeled off, except for a slight decrease in flux, still maintains high removal rates for algal toxins, geosmin, and 2-methylisoborneol. It does not damage the physicochemical properties and performance of the conductive FO membrane and has strong chemical practicality and durability.

The base membrane provided by the present application is reusable, cost-effective, and reduces environmental pollution.

The above has provided a detailed introduction to the conductive base membrane and its preparation method provided by the present application, as well as the conductive FO membrane using the conductive base membrane of the present application and its preparation method, the algal water separation system and method. For those of ordinary skill in the art, according to the ideas of the embodiments of the present application, there will be changes in the specific implementation and scope of application. In summary, the content of this specification should not be construed as limiting the present application.

What is claimed is:

1. A preparation method for a conductive base membrane, comprising:
Step 1: obtaining a conductive porous substrate of a suitable size, and performing a neutral treatment on the conductive porous substrate;
Step 2: performing an electrochemical material deposition on the substrate from step 1 to obtain a conductive material layer, wherein the conductive material layer is a material having negative electrons and high hydrophilicity.

2. The preparation method for a conductive base membrane in accordance with claim 1, wherein the conductive porous substrate is conductive porous carbon paper.

3. The preparation method for a conductive base membrane in accordance with claim 2, wherein the solution for the electrochemical material deposition in the step 2 is an electrochemical polymer, which is a mixture of pyrrole and H₂SO₄.

4. The preparation method for a conductive base membrane in accordance with claim 3, wherein the mixture of pyrrole and H₂SO₄ is obtained by a method comprising: fully dissolving 10.35 mL (0.15 mol) of a pyrrole solution, 3.0 mL of ethylene glycol, 3.0 mL of oxalic acid, and 13.40 g of sodium dodecyl benzene sulfonate (SDBS) in 500 mL of deionized water; taking 16.1 mL of concentrated sulfuric acid (98%) and completely dissolving it in 500 mL of deionized water; and finally mixing the two solutions to obtain the electrochemical polymer.

5. A conductive base membrane, comprising a support layer, wherein the support layer is constituted by a conductive porous substrate, a conductive material layer is disposed on the support layer, the conductive base membrane has high hydrophilicity, a porous structure, and carries a negative charge; and the surface of the conductive base membrane has a smooth morphology and a multi-pore size structure with uniform roughness; wherein the conductive base membrane is prepared by a method comprising:
Step 1: obtaining a conductive porous substrate of a suitable size, and performing a neutral treatment on the conductive porous substrate;
Step 2: performing an electrochemical material deposition on the substrate from step 1 to obtain a conductive material layer.

6. The conductive base membrane in accordance with claim 5, wherein the conductive material layer is a material having negative electrons and high hydrophilicity; and the conductive porous substrate is conductive porous carbon paper.

7. The conductive base membrane in accordance with claim 6, wherein the solution for the electrochemical material deposition in the step 2 is an electrochemical polymer, which is a mixture of pyrrole and H₂SO₄.

8. The conductive base membrane in accordance with claim 7, wherein the mixture of pyrrole and H₂SO₄ is obtained by a method comprising: fully dissolving 10.35 mL (0.15 mol) of a pyrrole solution, 3.0 mL of ethylene glycol, 3.0 mL of oxalic acid, and 13.40 g of sodium dodecyl benzene sulfonate (SDBS) in 500 mL of deionized water; taking 16.1 mL of concentrated sulfuric acid (98%) and completely dissolving it in 500 mL of deionized water; and finally mixing the two solutions to obtain the electrochemical polymer.

9. The conductive base membrane in accordance with claim 8, wherein the surface pore size of the conductive base membrane is in the range of 0.93±4.5 μm to 14.97±8.7 μm, and the porosity is in the range of 30.4±1.3% to 36.4±2.0%.

10. The conductive base membrane in accordance with claim 9, wherein the surface pore size of the conductive base membrane is 1.08±3.4 μm, and the porosity is 34.6±1.7%; or the surface pore size of the conductive base membrane is 1.08 μm, and the porosity is 34.6%; and the water contact angle of the base membrane is in the range of 29° to 88°.

11. The conductive base membrane in accordance with claim 9, wherein the porosity of the support layer is 41.4±1.5% and the average pore size is 280±11.4 μm; or the porosity of the support layer is 41.1% and the average pore size is 280 μm.

12. The conductive base membrane in accordance with claim 8, wherein the support layer is conductive porous carbon paper, and the conductive material layer is a polypyrrole layer.
